(19) United States
(12) Patent Application Publication
(10) Pub. No.: US 2026/0300223 A1
(43) Pub. Date: Oct. 1, 2026

(54) STORAGE SYSTEM AND DATA CONTROL METHOD

(71) Applicant: Hitachi Vantara, Ltd., Yokohama-shi (JP)

(72) Inventors: Yusuke YAMAGA, Tokyo (JP); Kenta SATO, Tokyo (JP); Akira DEGUCHI, Tokyo (JP)

(21) Appl. No.: 19/323,620

(22) Filed: Sep. 9, 2025

(30) Foreign Application Priority Data
Mar. 31, 2025 (JP) 2025-059155

(51) Int. Cl. G06F 16/11; G06F 16/174; G06F 16/182

(52) U.S. Cl. CPC G06F 16/128; G06F 16/1756; G06F 16/1824

(57) ABSTRACT

When a difference amount of parent-child difference data is smaller than a difference amount of inter-generation difference data, a migration source storage node transfers the parent-child difference data to the migration destination storage node, and when the difference amount of the inter-generation difference data is smaller than the difference amount of the parent-child difference data, the migration source storage node transfers the inter-generation difference data to the migration destination storage node, and the migration destination storage node uses the received data of the volume and the received inter-generation difference data or the received parent-child difference data to associate the volume and the plurality of snapshot volumes with the migration destination storage node.

### CROSS-REFERENCE TO RELATED APPLICATION

The present application claims priority from Japanese application JP2025-059155, filed on Mar. 31, 2025, the content of which is hereby incorporated by reference into this application.

### BACKGROUND OF THE INVENTION

### 1. Field of the Invention

The present invention relates to a storage system and a data control method, and is suitably applied to, for example, a storage system related to a technology using a snapshot function.

### 2. Description of Related Art

A snapshot function is present as an important function in a storage device. The snapshot function is a function of creating a duplication of data stored in a storage device at a certain moment (point-in-time). In the duplication by the snapshot function, mapping information between a logical storage area called a volume and a physical storage area such as a hard disk drive (HDD) or a solid state drive (SSD) is duplicated instead of duplicating an entity of data. Therefore, the duplication by the snapshot function can be performed in a short time. Data sharing and difference management are performed using mapping information between a created snapshot volume and a primary volume serving as a duplication source. At this time, the storage device consumes only a storage capacity equal to a data capacity of one volume plus a capacity of difference data indicating a difference between the volumes. In addition, restore processing for restoring the data of the primary volume using a snapshot volume has a feature that it can be processed in a short time by restoring only the difference data indicating the difference between the primary volume and the snapshot volume.

In general, an information technology (IT) system uses snapshots having such characteristics for various purposes. The most typical application is to acquire a snapshot volume as a backup of a primary volume to be used for a production work. In recent years, as a countermeasure against Ransomware, it is required to acquire a backup at a high frequency, and it is suitable to use the snapshot function in such a backup application. Further, the snapshot function can also be used for business purposes, such as analysis work for analyzing the acquired snapshot volume, that is, for secondary uses for purposes other than the production work. On the other hand, as a completely different application, for example, in a virtual desktop infrastructure (VDI), there is an application for deploying a virtual machine in which a drive for an operating system (OS) allocated to a large number of virtual machine (VM) is generated based on a volume serving as a master using the snapshot function.

Incidentally, in recent storage devices, there has been an increasing number of storage devices that achieve high scalability by implementing a plurality of storage nodes having the above-described primary volume and snapshot volume in a clustered manner. In such a storage device, IO processing for a volume, a storage capacity for holding data stored in the volume, and the like are often independent for each node. Regarding the snapshot function, the primary volume and the snapshot volume are arranged in the same node in order to maintain capacity consumption of only the difference data indicating the difference between the volumes.

In general, in such a storage device, control for distributing the volume to each node and control (rebalancing) for eliminating a deviation by migrating the volume among a plurality of storage nodes are performed so that the consumption of the storage capacity of each storage node and a calculation load associated with the IO processing are not deviated. When the snapshot function is used, the primary volume and the snapshot volume are migrated together.

PTL 1 discloses a method for migrating a primary volume and a snapshot volume from a migration source storage device to a migration destination storage device. Specifically, in the method disclosed in PTL 1, the oldest generation (hereinafter, referred to as the “oldest generation”) of migration source snapshot volumes is fully copied to a migration destination, inter-generation difference data is extracted from the oldest generation snapshot volume toward a latest generation snapshot volume, and the inter-generation difference data is sequentially transferred to the migration destination storage device. When the snapshot function is used as a backup of a volume to be used in a production work, the primary volume is updated from a host, while the snapshot volume is created from the primary volume at regular intervals. Therefore, in each snapshot volume, a data state of the primary volume at a certain moment is arranged in order from the oldest generation to the latest generation. Therefore, in the method disclosed in PTL 1, the difference data of the inter-generation difference data is sequentially transferred to the migration destination storage device from the oldest generation to the latest generation, so that the migration destination storage device can be migrated while maintaining the same capacity consumption as the migration source storage device.

### CITATION LIST

### Patent Literature

PTL 1: JP2009-181206A

### SUMMARY OF THE INVENTION

As described above, when the snapshot function is used for backup, the method disclosed in PTL 1 can be used without any problem. On the other hand, when the snapshot function is used for the purpose of deploying a virtual machine, different updates are performed on the snapshot volumes created from the volume serving as the master, and the inter-generation difference data has no order. Therefore, when the snapshot function is used for the purpose of deploying the virtual machine, the consumption of the storage capacity in a migration destination increases in the method disclosed in PTL 1.

The present invention has been made in view of the above points, and an object of the invention is to provide a storage system capable of preventing an increase in an amount of consumption of a storage area in a migration destination even when a primary volume is updated for a backup purpose and when a snapshot volume is updated for a purpose of deploying a virtual machine.

According to an aspect of the present invention, there is provided a storage system including: a plurality of storage nodes each having a processor. Each of the storage nodes includes a volume and a plurality of snapshot volumes that are snapshots of the volume, when migrating the volume and the plurality of snapshot volumes from a migration source storage node to a migration destination storage node, the migration source storage node transfers data of the volume to the migration destination storage node, compares a sum of difference amounts of parent-child difference data indicating differences between the volume as a migration target and the plurality of snapshot volumes with a sum of difference amounts of inter-generation difference data indicating inter-generation differences between the plurality of snapshot volumes, and transfers the parent-child difference data to the migration destination storage node when the difference amount of the parent-child difference data is smaller than the difference amount of the inter-generation difference data, and transfers the inter-generation difference data to the migration destination storage node when the difference amount of the inter-generation difference data is smaller than the difference amount of the parent-child difference data, and the migration destination storage node uses the received data of the volume and the received inter-generation difference data or the received parent-child difference data to associate the volume and the plurality of snapshot volumes with the migration destination storage node.

In the invention, a storage system includes: a plurality of storage nodes each having a processor. Each of the storage nodes includes a volume and a plurality of snapshot volumes that are snapshots of the volume, and each of the snapshot volumes is created by duplicating the volume, data is writable into the snapshot volume after creation, and has a snapshot image before being written into the snapshot volume, which is a snapshot image during creation of the snapshot volume, when the volume and the plurality of snapshot volumes are migrated from a migration source storage node to a migration destination storage node, the migration source storage node transfers, to the migration destination storage node, data of the volume, inter-generation difference data indicating differences between snapshot volumes during creation of the plurality of snapshots, and parent-child difference data that is data written into the snapshot volume after creation, and the migration destination storage node uses the received data of the volume, the received inter-generation difference data, and the received parent-child difference data to associate the volume with the plurality of snapshot volumes at the migration destination storage node.

In the invention, a storage system includes: a plurality of storage nodes each having a processor. Each of the storage nodes includes a volume and a plurality of snapshot volumes that are snapshots of the volume, and when the volume and the plurality of snapshot volumes are migrated from a migration source storage node to a migration destination storage node, the migration source storage node transfers, to the migration destination storage node, data of the volume and parent-child difference data indicating differences between the volume and the plurality of snapshot volumes, and the migration destination storage node uses the received data of the volume and the received parent-child difference data to create the volume and the plurality of snapshot volumes in the migration destination storage node.

According to the invention, it is possible to prevent an increase in the amount of consumption of a storage area at a migration destination even when a primary volume is updated for a backup purpose or a snapshot volume is updated for a purpose of deploying a virtual machine.

### BRIEF DESCRIPTION OF THE DRAWINGS

FIG. 1 is a diagram showing a configuration example of a system including a storage system according to a first embodiment.

FIG. 2 is a block diagram showing an example of a logical configuration of the storage system according to the first embodiment.

FIG. 3 is a diagram showing an outline of processing as a comparative example for migrating a primary volume and a snapshot volume from a migration source storage node to a migration destination storage node.

FIG. 4 is a functional block diagram showing a logical configuration example of a storage node according to the first embodiment.

FIG. 5 shows a configuration example of a storage node management table shown in FIG. 4.

FIG. 6 is a diagram showing a configuration example of a volume management table shown in FIG. 4.

FIG. 7 is a diagram showing a configuration example of a volume control table shown in FIG. 4.

FIG. 8 is a diagram showing a configuration example of a snapshot generation management table shown in FIG. 4.

FIG. 9 is a flowchart showing an example of a procedure of snapshot migration processing.

FIG. 10 is a diagram illustrating an effect produced by the storage system according to the first embodiment.

FIG. 11 is a functional block diagram showing a logical configuration example of a storage node according to a second embodiment.

FIG. 12 is a diagram showing a configuration example of a volume control table according to the second embodiment.

FIG. 13 is a diagram showing a configuration example of a mapping table according to the second embodiment.

FIG. 14 is a flowchart showing an example of a procedure of snapshot migration processing according to the second embodiment.

FIG. 15 is a diagram illustrating effects of the second embodiment.

FIG. 16 is a block diagram showing a configuration example of an entire system including a storage system according to a third embodiment.

FIG. 17 is a block diagram showing an example of a logical configuration of the storage system according to the third embodiment.

FIG. 18 is a block diagram showing a logical configuration example of the storage system and a management server according to the third embodiment.

FIG. 19 is a block diagram showing a configuration example of a storage system management table according to the third embodiment.

FIG. 20 shows a configuration example of a volume management table according to the third embodiment.

### DESCRIPTION OF EMBODIMENTS

Hereinafter, the present embodiment of the invention will be described in detail with reference to the drawings. The following description and drawings are examples for describing the invention, and are omitted and simplified as appropriate for clarification of the description, and do not limit the technical scope of the invention.

In the following description, information from which an output is obtained with respect to an input may be described by an expression such as “xxx table”, but the information may be data of any structure or may be a training model such as a neural network that generates an output with respect to an input. Therefore, the “xxx table” can be referred to as “xxx information”.

In the following description, a configuration of each table is an example. One table may be divided into two or more tables, or all or some of two or more tables may be one table. In the following description, processing may be described using a “program” as a subject, but since a program is executed by a processor unit to perform predetermined processing using a storage unit and/or an interface unit as appropriate, the subject of the processing may be the processor unit (or a device such as a controller including the processor unit).

The program may be installed in a device such as a computer, or may be, for example, a program distribution server or a computer-readable (for example, non-transitory) recording medium. In the following description, two or more programs may be implemented as one program, or one program may be implemented as two or more programs.

In the following description, a “computer system” is a system including one or more physical computers. The physical computer may be a general-purpose computer or a dedicated computer. The physical computer may function as a computer (for example, a host computer) that issues an input/output (I/O) request, or may function as a computer (for example, a storage device) that performs I/O of data in response to the I/O request.

That is, the computer system may be at least one of a host system that is one or more host computers that issue an I/O request and a storage system that is one or more storage devices that perform I/O of data in response to an I/O request. In the at least one physical computer, one or more virtual computers (for example, virtual machine (VM)) may be executed. The virtual computer may be a computer that issues an I/O request or a computer that performs I/O of data in response to an I/O request.

The computer system may be a distributed system including one or more (typically, a plurality of) physical node devices. The physical node device is a physical computer.

A physical computer (for example, a node device) may execute predetermined software to construct software-defined anything (SDx) in the physical computer or a computer system including the physical computer. As the SDx, for example, a software defined storage (SDS) or a software-defined datacenter (SDDC) may be adopted.

For example, a storage system as an SDS may be constructed by executing software having a storage function on a physical general-purpose computer.

In addition, at least one physical computer (for example, a storage device) may execute one or more virtual computers as a host system and a virtual computer as a storage controller (typically, a device that inputs and outputs data to and from a storage device in response to an I/O request) of the storage system.

In other words, such at least one physical computer may function as at least part of a host system and as at least part of a storage system.

The computer system (typically, the storage system) may include a redundant configuration group. A redundant configuration may be a configuration in a plurality of node devices such as Erasure Coding, redundant array of independent nodes (RAIN), and mirroring between nodes, or may be a configuration in a single computer (for example, a node device) such as one or more redundant array of independent (or inexpensive) disks (RAID) groups as at least a part of storage devices.

In addition, in the following description, a “data set” is a block of logical electronic data viewed from a program such as an application program, and may be, for example, any of a record, a file, a key value pair, and a tuple.

In the following description, an identification numeral is used as identification information of various targets, and identification information of a type other than the identification numeral (for example, an identifier including an alphabetic character or a code) may be adopted.

In addition, in the following description, when elements of the same type are described without being distinguished, a reference numeral (or a common numeral of the reference numerals) may be used, and when elements of the same type are distinguished and described, identification numerals (or the reference numerals) of the elements may be used.

For example, when a “page” which is a unit of a storage area is described without being particularly distinguished, it may be described as a “page 312”, and when individual pages are described separately, it may be described as “page #0” or “page #1” using a page number or as a “page 312A” or a “page 312B” using a reference numeral. In the present embodiment, “#” means an identifier such as a number.

### (1) First Embodiment

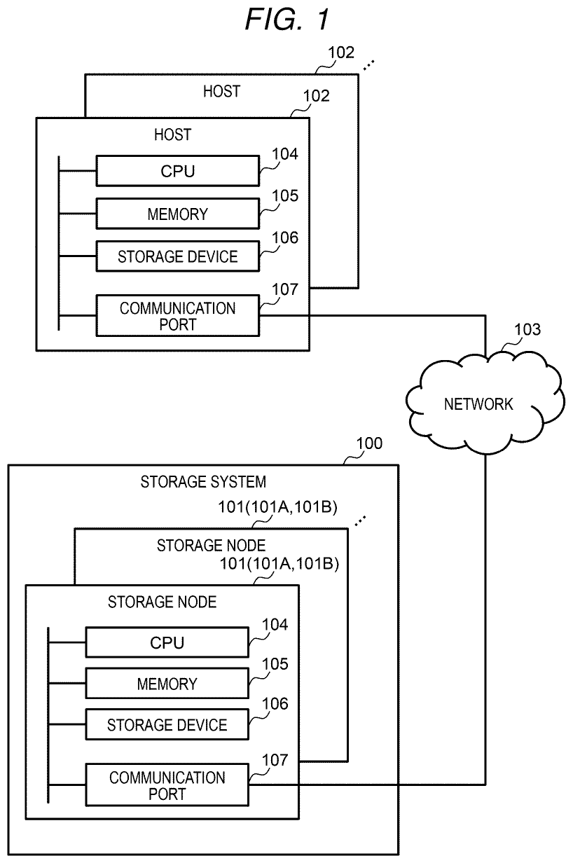

Hereinafter, the first embodiment will be described with reference to FIGS. 1 to 10.

FIG. 1 shows a configuration example of a system including a storage system 100 according to the first embodiment. The storage system 100 includes two or more storage nodes 101. A host 102 transmits, to the storage node 101, an I/O request (write request or read request) designating a logical volume number such as an I/O destination (for example, a logical unit number (LUN)) or a logical address such as a logical block address (LBA).

The storage system 100 and the host 102 need not be installed at the same point, and for example, the storage node 101 and the host 102 may be installed in different data centers. Similarly, the storage node 101 and the host 102 may be physically implemented by one device. For example, a configuration may be adopted in which a function as the storage node 101 and a function as the host 102 are shared by one physical server, such as a hyper converged infrastructure (HCI). In the present embodiment, the storage system 100 implemented by clustering the storage nodes 101 may be treated as one storage node 101 to implement a larger scale and hierarchical storage system 100.

Each of the storage node 101 and the host 102 is a computer including a CPU 104, a memory 105, a storage device 106, and a communication port 107, and a strict configuration is not limited as long as the storage node 101 and the host 102 can play respective roles to be described later. In the storage node 101 and the host 102, a plurality of components may be mounted, or components other than those described above may be mounted. For example, as the storage device 106, a plurality of hard disk drives may be mounted for redundancy, or an accelerator such as a graphics processing unit (GPU) may be mounted in order to substitute for a part of processing performed by the CPU 104. Each component may be virtual hardware based on a virtualization technique, such as a virtual machine or a container, instead of physical hardware. Similarly, a service that executes a program without being conscious of an actual computing environment, such as function-as-a-service or serverless computing, may be used.

The storage node 101 and the host 102 constituting the storage system 100 are connected to a network 103 and can communicate with each other. The network 103 is implemented by any communication line such as Ethernet, InfiniBand, or an optical fiber and a combination thereof. In addition, the network 103 may include not only a local area network (LAN) closed in a data center but also a wide area network (WAN) such as the Internet and a virtual network inside a computer. Although not shown, the network devices such as a network switch, a router, and a gateway may be included as necessary. In the shown example, all the components are connected to one network 103, and a dedicated network used between specific components may be provided. The storage system 100 may include, for example, a dedicated network to speed up communication between the storage nodes 101.

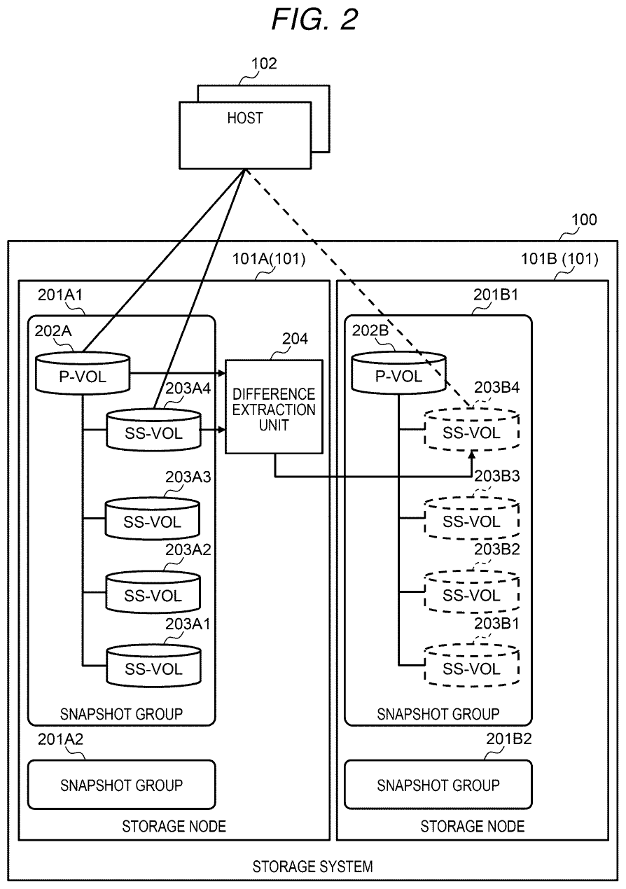

FIG. 2 is a block diagram showing an example of a logical configuration of the storage system 100 according to the first embodiment. The storage system 100 is obtained by clustering a plurality of storage nodes (two storage nodes in the shown example) 101A and 101B. In the present embodiment, the plurality of storage nodes 101A and 101B may be collectively referred to as the storage node 101. Each storage node 101 provides a logical storage area called a volume to the host 102. The host 102 reads and writes data from and to the volumes provided from the storage system 100 and the storage node 101 according to various kinds of processing executed on the host 102.

In the migration source storage node 101A, a migration source primary volume 202A is a normal volume. For example, in response to a user instruction, for example, migration source snapshot volumes 203A1 to 203A4 are acquired as migration source snapshot volumes for the migration source primary volume 202A. In the migration destination storage node 101B, for example, migration source snapshot volumes 203B1 to 203B4 are acquired as migration source snapshot volumes for a migration destination primary volume 202B. The primary volumes 202A and 202B may also be collectively referred to as the migration source primary volume 202, and the snapshot volumes 203A1 to 203A4, 203B1 to 203B4 may also be collectively referred to as the migration source snapshot volume 203.

The snapshot volume 203 is a volume copied using the snapshot function based on the primary volume 202. In the present embodiment, the primary volume may be referred to as “P-VOL”, and the snapshot volume may be referred to as “SS-VOL”. Each of the P-VOL 202 and the SS-VOL 203 is a volume provided to the host 102 and readable and writable by the host 102. Depending on an implementation form of the snapshot function, there may be the SS-VOL 203 further provided with a cascade function that enables acquisition of a snapshot, but this is omitted in the present embodiment.

In the shown example, there are four snapshot volumes SS-VOLs 203A1 to 203A4 for the P-VOL 202, and each of the snapshot volumes receives an IO from the host 102. The shown example shows an example of an operation of migrating the SS-VOL 203A4 from the migration source storage node 101A to the storage node 101B in the processing of migrating the P-VOL 202A and the SS-VOLs 203A1 to 203A4 of the snapshot group 201A1 of the migration source storage node 101A to the storage node 101B. This migration processing will be described later. In the present embodiment, the P-VOL 202A and the P-VOL 202B described later are also collectively referred to as the “P-VOL 202”.

The snapshot group 201 is a group indicating a set of volumes in which difference management of data by the snapshot function (that is, management of a data sharing relationship using mapping information) is performed, and includes one P-VOL 202 or one or more SS-VOL 203s.

A difference extraction function unit 204 of the storage node 101A is a part of the snapshot function, and is a function of extracting a difference area as an area in which data is different between a plurality of volumes with respect to any volumes (the P-VOL 202 and the SS-VOL 203) in the snapshot group 201 of a single node. In the present embodiment, since the difference management is performed by the snapshot function in the volume in the snapshot group 201 of the single node, the difference can be extracted at a high speed without comparing entities of the data. The above-described difference management is, for example, management of a data sharing relationship using mapping information. The function is used in migration processing to be described later.

In the present embodiment, in the migration processing, it is assumed that the IO reception from the host 102 to the SS-VOL 203A4 is temporarily stopped, and the IO reception is resumed using the SS-VOL 203B4 after the migration processing is completed. Therefore, the IO from the host 102 cannot be received during the execution of the migration processing. For example, by duplicating an IO request received during the execution of the migration processing to the SS-VOL 203A4 and the SS-VOL 203B4, it is also possible to perform the migration while maintaining the IO reception from the host 102. In the present embodiment, as an example, it is assumed that the IO reception is temporarily stopped.

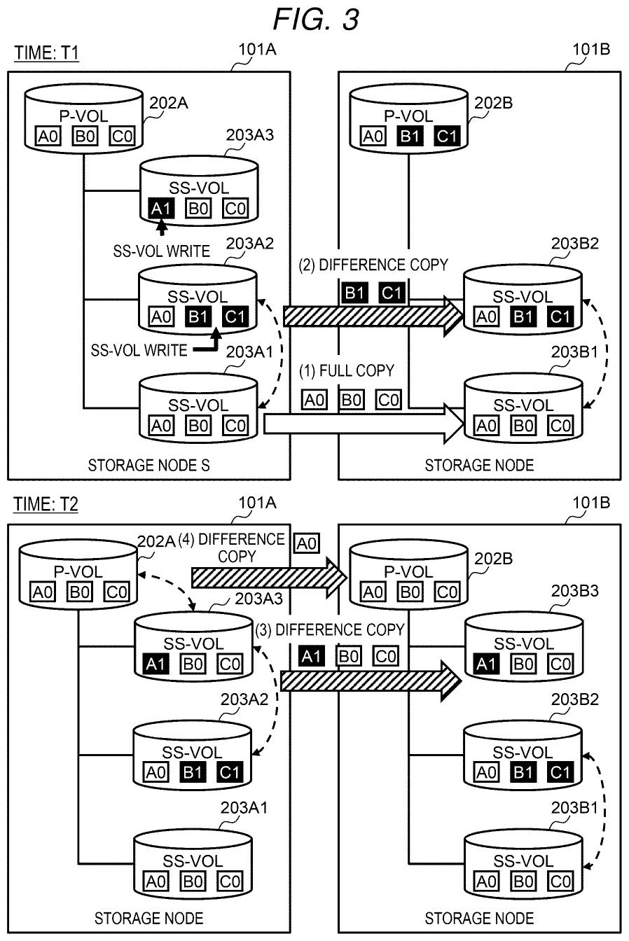

FIG. 3 is a diagram showing an outline of processing as a comparative example in which the P-VOL 202A and the SS-VOLs 203A1 to 203A3 are migrated from the migration source storage node 101A to the migration destination storage node 101B. FIG. 3 shows a comparative example with the processing to be described later.

In the shown example, the migration processing proceeds from a time T1 to a time T2. In a state before the migration processing, data sets A0, B0, and C0 are written from the host 102 to the P-VOL 202A. For the purpose of deploying a virtual machine, the SS-VOLs 203A1 to 203A3 are created from the P-VOL 202A. Among the SS-VOLs 203A1 to 203A3, data sets B1 and C1 are written from the host 102 to the second generation SS-VOL 203A2, and the data set A1 is written from the host 102 to the third generation SS-VOL 203A3.

In the shown example, for example, the snapshot volume of the oldest generation, which is the oldest generation among the migration source snapshot volumes, is fully copied to the migration destination storage node 101B, inter-generation difference data is extracted from the snapshot volumes of the oldest generation to the latest generation, and the difference data is sequentially transferred to the migration destination primary volume 202B.

Therefore, in the state at the time T1, first, as a procedure (1), the data sets A0, B0, and C0 of the SS-VOL 203A1, which is the oldest generation snapshot volume, are fully copied to the P-VOL 202B of the migration destination storage node 101B, and the migration of the oldest generation (migration from the SS-VOL 203A1 to the SS-VOL 203B1) is completed by creating the SS-VOL 203B1 based on the P-VOL 202B.

Next, as a procedure (2), the data sets B1 and C1 of the difference area between the migration source SS-VOL 203A1 and the SS-VOL 203A2 are differentially copied to the P-VOL 202B of the migration destination storage node 101B, and the SS-VOL 203B2 is created from the P-VOL 202B.

A state at the time T2 shows a state in which the migration processing of the procedure (2) is applied between generations and the migration to the migration destination storage 101B is completed up to the P-VOL 202A. In a procedure (3), the inter-generation difference data sets A1, B0, and C0 indicating the difference between the migration source SS-VOL 203A2 and the SS-VOL 203A3 are differentially copied to the migration destination storage node 101B. However, the data sets B0 and C0 are the data sets already copied in the procedure (1). In a procedure (4) as well, the difference data set indicating the difference between the SS-VOL 203A3 and the P-VOL 202A is A0. However, the data set A0 is also the data set already copied in the procedure (1). In the present comparative example, each of the data sets A0, B0, and C0 is transferred to the migration destination storage node 101B twice, and a consumption of a storage capacity in the migration destination may increase.

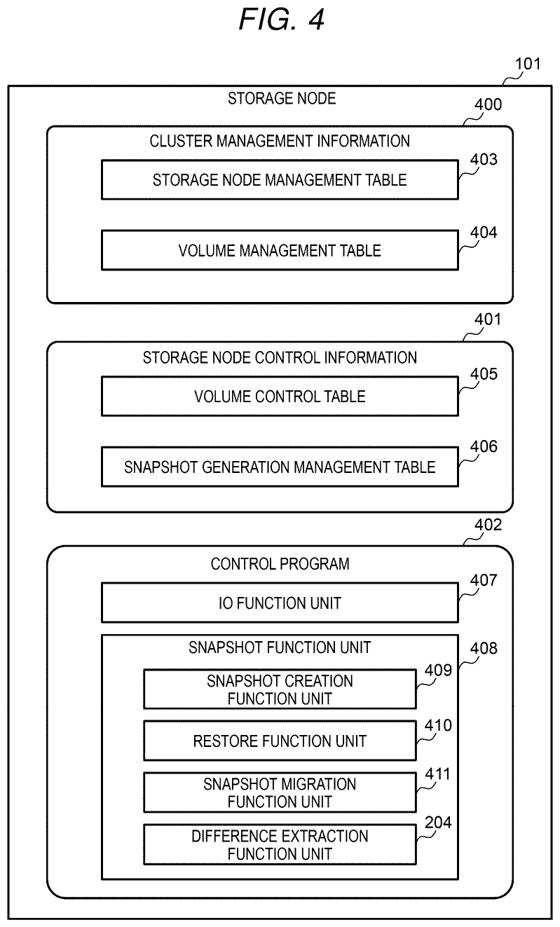

Next, with reference to FIGS. 4 to 10, a description will be given of the present embodiment for eliminating the possibility that the consumption of the storage capacity in the migration destination described above increases.

FIG. 4 is a functional block diagram showing a logical configuration example of the storage node 101 according to the first embodiment. Each of the storage nodes 101 constituting the storage system 100 includes cluster management information 400, storage node control information 401, and a control program 402.

The cluster management information 400 is management information for clustering a plurality of storage nodes 101 to operate as one storage system 100. The cluster management information 400 includes a storage node management table 403 and a volume management table 404. The storage node management table 403 is a table for managing the storage nodes 101 constituting the storage system 100. The volume management table 404 is a table for managing the configuration of volumes and snapshots to be managed by the storage system 100. The cluster management information 400 may be actually held by all the storage nodes 101 constituting the storage system 100, or may be held only by the representative migration source storage node 101B.

The storage node control information 401 is control information to be used by the control program 402 operating in the storage node 101 to perform IO processing to a volume and operation of a snapshot function. The storage node control information 401 is information unique to each of the storage nodes 101. The storage node control information 401 includes a volume control table 405 and a snapshot generation management table 406. Although omitted in the shown example, the storage node control information may further include, for example, information for controlling the storage device 106 and information for controlling the communication port 107. The volume control table 405 and the snapshot generation management table 406 are control information necessary for the IO processing to the volume and the operation of the snapshot function.

The control program 402 is a program for achieving the IO processing to the volume and the operation of the snapshot function by controlling the storage device 106 and the communication port 107 of the storage node 101 using the storage node control information 401. The control program 402 includes an IO function unit 407 and a snapshot function unit 408.

The IO function unit 407 provides a volume to the host 102 and processes an IO request requested from the host 102 to the volume. Meanwhile, the snapshot function unit 408 achieves a snapshot function. The snapshot function unit 408 includes a snapshot creation function unit 409, a restore function unit 410, a snapshot migration function unit 411, and a difference extraction function unit 204.

The snapshot creation function unit 409 creates a new SS-VOL 203 based on the designated P-VOL 202. The restore function unit 410 executes restore processing of restoring the data of a volume in the snapshot group 201 using a designated volume. The snapshot migration function unit 411 executes processing of migrating the P-VOL 202 and the SS-VOL 203 of the designated snapshot group 201 to another storage node 101.

The configuration of the control program 402 in the present embodiment is subdivided in consideration of ease of description, and an actual structure may be significantly different. For example, in the IO processing for the volume to which the snapshot function is applied, the IO function unit 407 and the snapshot function unit 408 need to closely cooperate with each other, and in practice, the control program cannot be clearly divided into two functions.

The storage system 100 has various functions in addition to the snapshot function described above, which are omitted in present embodiment. Further, regarding the IO function unit 407 and the snapshot function unit 408, descriptions of functions that are not directly related to the present embodiment will be omitted. In addition, a function of transmitting and receiving data between the plurality of storage nodes 101, a function of receiving an instruction from a user, a function of maintaining information such as the storage node management table 403 and the volume management table 404 in a latest state, and the like are also omitted. The cluster management information 400 and the storage node control information 401 also include various kinds of information, which are omitted here.

The storage system 100 according to the present embodiment includes a plurality of storage nodes having the processor CPU 104, and the migration source storage node 101A and the migration destination storage node 101B as an example of the plurality of storage nodes include volumes and a plurality of snapshot volumes that are snapshots of the volumes. Here, in general, during the snapshot migration, an amount of transfer data is smaller when inter-generation difference data indicating an inter-generation difference of a plurality of migration source snapshot volumes is transferred than when parent-child difference data indicating a difference between a migration source volume as a migration target and a plurality of migration source snapshot volumes is transferred. However, the snapshot can be written to the snapshot volume after the snapshot is created, but in this case, the snapshot changes only for one generation, and there are, for example, an amount of written data and an amount of data to which the writing is returned in the next generation, so that the inter-generation difference data increases. Therefore, in the present embodiment, the difference data to be transferred from the transfer source storage node 101A to the transfer destination storage node 101B is switched between the two types of the inter-generation difference data and the parent-child difference data by using the fact that a transfer amount of the parent-child difference data is smaller than that of the inter-generation difference data depending on the writing to the snapshot.

Specifically, when the volume and the plurality of snapshot volumes are migrated from the migration source storage node 101A to the migration destination storage node 101B, the migration source storage node 101A transfers the data of the volume to the migration destination storage node 101A, for example, compares a total amount of the difference amounts of the parent-child difference data indicating the difference between the migration source P-VOL 202A as the migration target and the plurality of migration sources SS-VOL 203A1 to 203A4 with a total amount of the difference amounts of the inter-generation difference data indicating the inter-generation difference of the plurality of migration sources SS-VOL 203A1 to 203A4, and transfers the parent-child difference data to the migration destination storage node 101B when the difference amount (or a total amount thereof) of the parent-child difference data is smaller than the difference amount (or a total amount thereof) of the inter-generation difference data. Further, when the difference amount (or the total amount thereof) of the inter-generation difference data is smaller than the difference amount (or the total amount thereof) of the parent-child difference data, the migration source storage node 101A transfers the inter-generation difference data to the migration destination storage node 101B. The migration destination storage node 101B associates the migration destination P-VOL 202B and the plurality of migration destinations SS-VOL 203B1 to 203B4 with the migration destination storage node 101B using the received volume data and the received parent-child difference data. Normally, the host 102 reads and writes data from and to the migration source P-VOL 202A, which is the primary volume of the migration source storage node 101A, but in the present embodiment, for example, data may be read and written from and to the migration source P-VOL 202B, which is the primary volume of the migration destination storage node 101B.

The snapshot volume is created by duplicating a volume, and is writable into the snapshot volume after creation. The migration source storage node 101A manages a snapshot group including a migration source P-VOL 202A and a plurality of migration sources SS-VOL 203A1 to 203A4. The migration source storage node 101A transfers the migration source P-VOL 202A and the plurality of migration sources SS-VOL 203A1 to 203A4 in units of snapshot groups, and creates the migration destination P-VOL 202B and the plurality of migration destinations SS-VOL 203B1 to 203B4 in the migration destination storage node 101B.

The migration source storage node 101A compares the migration source P-VOL 202A with the plurality of migration sources SS-VOL 203A1 to 203A4, and extracts the parent-child difference data and the inter-generation difference data. The migration source storage node 101A determines the parent-child difference data or the inter-generation difference data to be transferred to the migration destination storage node 101B.

The migration source storage node 101A transfers the volume and a snapshot image of each generation of the plurality of migration destinations SS-VOL 203A1 to 203A4 to the migration destination storage node 101B together with the difference data between the plurality of migration sources SS-VOL 203A1 to 203A4.

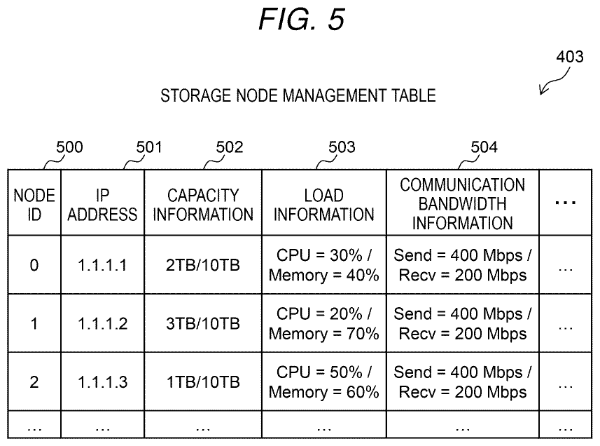

FIG. 5 is a diagram showing a configuration example of the storage node management table 403 shown in FIG. 4. The storage node management table 403 is a table for managing the storage nodes 101 constituting the storage system 100. Entries of the storage node management table 403 include, for example, a node ID 500, an Internet Protocol (IP) address 501, capacity information 502, load information 503, and communication bandwidth information 504.

The node identifier (ID) 500 is identification information for uniquely identifying the storage node 101 in the storage system 100. In the shown example, the node ID 500 is a serial number, and may not be a serial number and may be an identifier (ID) using characters other than numbers. The IP address 501 is connection destination information for communication between the storage nodes 101. Further, the IP address 501 is connection destination information to be used by the host 102 to access a volume provided by the storage node 101.

In the shown example, each of the storage nodes 101 has one IP address, and when the storage node 101 has a plurality of communication ports 107, the storage node may have connection information for each of the communication ports. The capacity information 502 is information indicating a total amount and a usage amount of the storage capacity that the storage node 101 can provide to the host 102. The load information 503 is information indicating a utilization status of a calculation resource (the CPU 104 or the memory 105)) consumed by the storage node 101 for IO processing to the volume or the like. The communication bandwidth information 504 is information indicating the utilization status of the communication port 107 consumed by the storage node 101 for IO processing from the host to the volume, snapshot migration processing, and the like.

In the shown example, the storage node 101 in which the node ID 500 is “0” has the IP address 501 of “1.1.1.1”, a total amount of the storage capacity of “10 TB” with “2 TB” being used, “30%” of the CPU 104 and “40%” of the memory 105 are used for the IO processing or the like, and “400 Mbps” is used in a transmission direction and “200 Mbps” is used in a reception direction for the communication port 107.

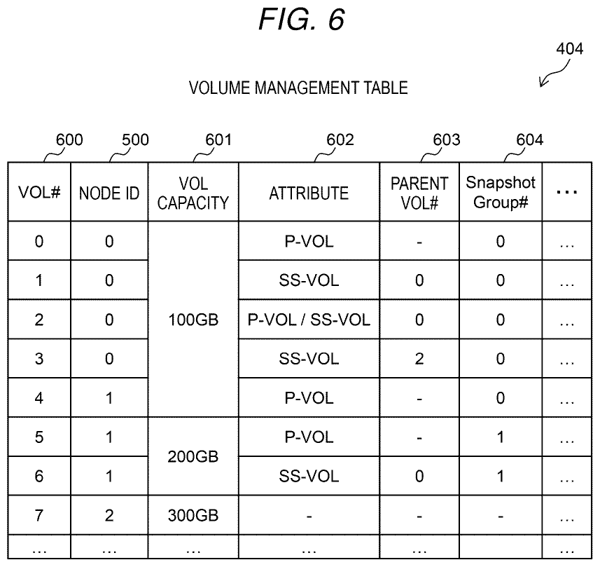

FIG. 6 is a diagram showing a configuration example of the volume management table 404 shown in FIG. 4. The volume management table 404 is a table for managing the configuration of volumes and snapshots to be managed by the storage node 101. Entries of the volume management table 404 include, for example, a volume number (VOL #) 600, the node ID 500, a volume capacity 601, a volume attribute 602, a parent volume number (parent VOL #) 603, and a snapshot group #604. Note that, #indicates a number.

The volume # is information for uniquely identifying a volume in the storage system 100. In the shown example, the volume # is a serial number, and may not be a serial number and may be an ID using characters other than numbers. The node ID 500 is information indicating an ID of the storage node 101 in which the volume is stored. The volume capacity 601 is information indicating a storage capacity of the volume.

The volume attribute 602 is information indicating that the volume is a volume being used for what purpose. “P-VOL” indicates that a snapshot function is applied to the volume and the volume is P-VOL 202. “SS-VOL” indicates that a snapshot function is applied to the volume and the volume is the SS-VOL 203. “−” indicates that a function such as a snapshot function is not applied to the volume and the volume is a normal volume. A plurality of values may be set in the volume attribute 602. For example, “P-VOL/SS-VOL” indicates that the volume is a snapshot volume created using a snapshot function based on a certain P-VOL 202, and the volume is also a P-VOL having a certain SS-VOL 203.

The parent volume #603 is information indicating an ID of the P-VOL 202 that is a source of a snapshot when the volume is a snapshot volume, that is, when the volume has “SS-VOL” as the volume attribute 602. When the volume is a primary volume or a normal volume to which the snapshot function is not applied, “−” is stored.

The snapshot group #604 is information for uniquely identifying the snapshot group 201 to which the volume belongs. In the shown example, the snapshot group #604 is a serial number, and may not be a serial number and may be a number using characters other than numbers. When the volume is a normal volume to which the snapshot function is not applied, “−” is stored. The snapshot group #604 is newly numbered when a first snapshot is acquired with a normal volume to which the snapshot function is not applied as a primary volume.

In the shown example, a volume whose volume #600 is “0” is stored in the storage node 101 whose node ID 500 is “0”, has a storage capacity of “100 GB”, is used as a primary volume in the snapshot function, and belongs to the snapshot group 201 whose snapshot group #604 is “0”.

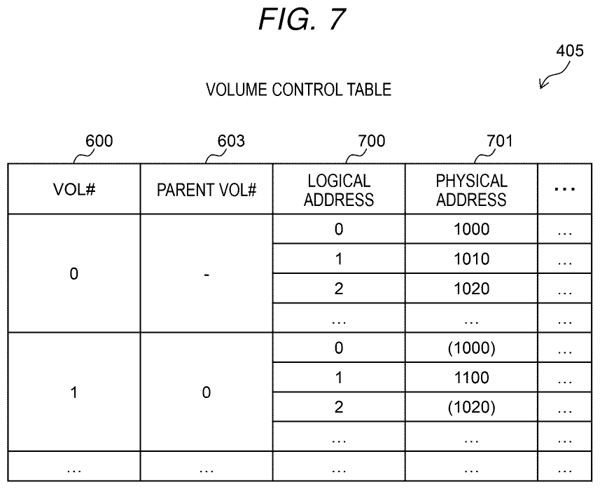

FIG. 7 is a diagram showing a configuration example of the volume control table 405 shown in FIG. 4. The volume control table 405 is control information to be used by the control program 402 operating in the storage node 101 to perform the IO processing to the volume and operation of the snapshot function, and the volume control table 405 is information unique to each storage node 101. Entries of the volume control table 405 include the volume #600, the parent volume #603, a logical address 700, and a physical address 701.

The volume #600 and the parent volume #603 are the same information as the volume management table 404. The logical address 700 is information for designating a position of data to be read and written when the host 102 performs IO for the volume. The physical address 701 is mapping information indicating which position (physical address 701)) of the storage device 106 a data block of the logical address 700 of the volume is stored in. When the volume is a snapshot volume, that is, when the volume has “SS-VOL” as the volume attribute 602, the physical address 701 has a parenthesis such as “(1000)”. The parenthesis indicates that the data of the logical address 700 is shared with the primary volume indicated by the parent volume #603.

Normally, immediately after a snapshot is acquired, the entire area of a snapshot volume is shared with a primary volume, and thereafter, the host 102 writes data to the snapshot volume or the primary volume, thereby releasing the sharing. A method for managing mapping information and actual data in such a snapshot function is implemented using a control method such as copy on write or redirect on write. Since these are all known techniques, in the present embodiment, it is assumed that the control program 402 appropriately performs the IO processing or the snapshot operation on an extension line, and details thereof will be omitted.

In the shown example, a volume in which the volume #600 is “1” is a volume created as a snapshot of a primary volume in which the volume #600 is “0”. A data block whose logical address 700 is “0” shares data with the primary volume, and is stored in an area whose physical address 702 is “1000”. A data block whose logical address 700 is “1” is stored in an area whose physical address 701 is “1100”. A data block whose logical address 700 is “2” shares data with the primary volume and is stored in an area whose physical address 701 is “1020”.

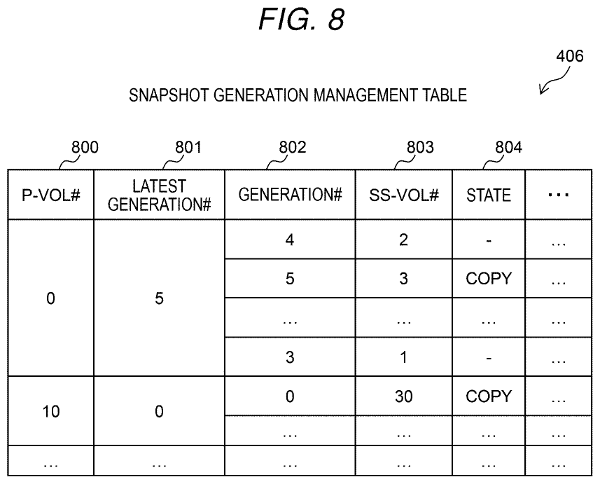

FIG. 8 is a diagram showing a configuration example of the snapshot generation management table 406 shown in FIG. 4. The snapshot generation management table 406 is control information to be used by the control program 402 operating in the storage node 101 to operate the snapshot function. In the snapshot generation management table 406, a latest generation #801 is managed for each P-VOL #800. The latest generation #is information unique to each of the storage nodes 101. Entries of the snapshot generation management table 406 include the P-VOL #800, the latest generation #801, a generation #802, an SS-VOL #803, and a state 804. The snapshot generation management table 406 manages, for example, 1024 generations for each P-VOL (generation #=0 to 1023)).

In the snapshot generation management table 406, the latest generation #801 is incremented for each snapshot creation processing of the P-VOL 202, and the SS-VOL #803 and the state 804 corresponding to the latest generation #are updated. The state 804 includes a COPY state indicating that a snapshot is being created. When the snapshot creation processing is completed, the state 804 is a state becoming “−”.

Various kinds of information handled by the storage system 100 in the present embodiment are described above. In the above description, for example, information to be used for control in the present embodiment and information often included in the general storage system 100 are shown. New information may be added to these pieces of information as necessary, or some pieces of information may be deleted if unnecessary.

In the following description, processing contents by functions of essential parts in the present embodiment among the functions constituting the control program 402 will be described with reference to a flowchart. However, the processing described in the following description mainly refers to processing to be generally performed in order to perform the function of an essential part of the present embodiment, and description of a part that is not important in the present embodiment may be omitted. In the present embodiment, any processing may be added as necessary, and part of the processing may be deleted if unnecessary.

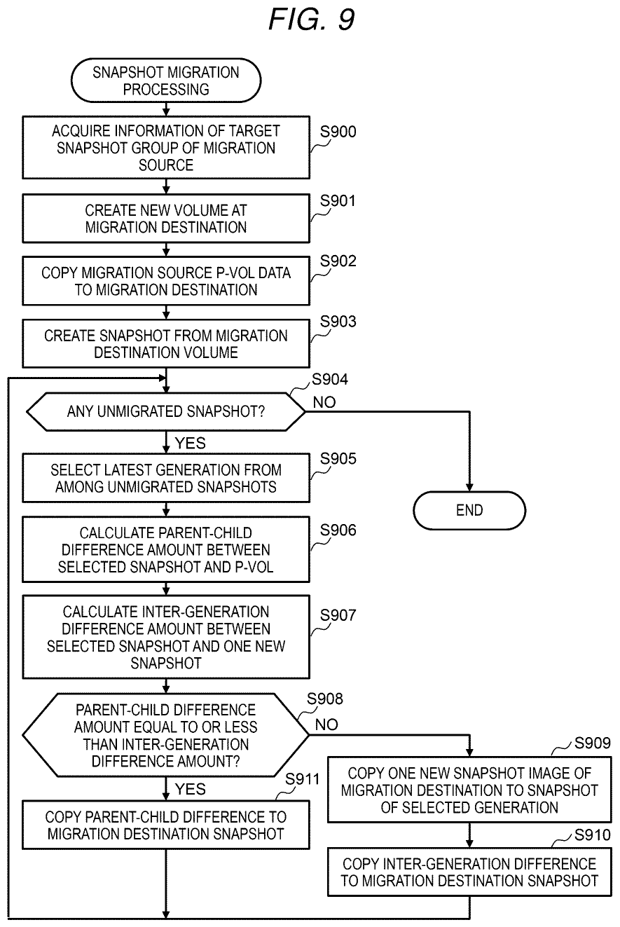

FIG. 9 is a flowchart showing an example of a procedure of the snapshot migration processing. The snapshot migration processing is mainly executed by the snapshot migration function unit 411 of the snapshot function unit 408. The snapshot migration function unit 411 is activated by the user instructing the storage system 100 to execute the migration processing of the snapshot group 201. In addition, the control program 402 in the storage system 100 may be implemented to periodically monitor the capacity information 502 and the load information 503 of the storage node management table 403 and autonomously perform migration to eliminate a deviation in a storage capacity and a calculation load when the deviation is detected.

In the present snapshot migration processing, first, the snapshot migration function unit 411 acquires information of the target snapshot group 201 serving as a migration source (step S900). The snapshot migration function unit 411 refers to the volume management table 404 and acquires volume information necessary for migration such as the volume #600, the node ID 500, the volume capacity 601, the volume attribute 602, and the parent volume #603 of the migration target snapshot group #604.

Next, in step S901, the snapshot migration function unit 411 creates a new volume having the same capacity as the migration source P-VOL 202 and SS-VOL 203 in the migration destination storage node 101 based on the information of the volume capacity 601 acquired in step S900.

The difference extraction function unit 204 extracts difference data indicating a difference between the P-VOL 202A of the migration source storage node 101A and each SS-VOL 203Ai (i=0, 1, . . . 1024). In order to transfer the difference data to the migration destination storage 101B, the difference extraction function unit 204 first copies all pieces of data of the reference P-VOL 202A to the volume created in step S901 by the migration destination storage node 101B (step S902).

Thereafter, in step S903, the snapshot migration function unit 411 creates SS-VOL 203Bi (i=0, 1, . . . 1024) from the P-VOL 202B of the migration destination storage node 101B. In step S903, the snapshot migration function unit 411 causes the snapshot creation function unit 408 to create as many SS-VOLs 203 as the number of the snapshot volumes 203 of the migration target snapshot group.

In step S904, the snapshot migration function unit 411 checks whether an unmigrated SS-VOL 203 still exists in the migration source storage node 101. Information indicating whether the migration is completed may be held in the volume management table 404 or in the state 804 of the snapshot generation management table 406. When the snapshot migration function unit 411 determines that there is an unmigrated SS-VOL 203 (step S904: Yes), the snapshot migration function unit 411 executes step S905, whereas when the snapshot migration function unit 411 determines that there is no unmigrated SS-VOL 203 (step S904: No), that is, when migration of all of the SS-VOLs 203 is completed, the snapshot migration function unit 411 ends the snapshot migration processing.

In step S905, the snapshot migration function unit 411 selects the most recent generation SS-VOL 203 among the unmigrated SS-VOLs 203. The snapshot migration function unit 411 refers to the snapshot generation management table 406 and selects the largest generation #802 among the SS-VOL #803 of the migration target P-VOL #800. When no SS-VOL 203 is migrated, the snapshot migration function unit 411 selects the migration source SS-VOL 203A4 shown in FIG. 2.

Next, in step S906, the snapshot migration function unit 411 calculates parent-child difference data indicating a difference between the SS-VOL 203 selected in step S905 and the primary volume 202 using the difference extraction function unit 204. In the case of the SS-VOL 203A3 shown in FIG. 2, the snapshot migration function unit 411 calculates parent-child difference data indicating a difference between the SS-VOL 203A3 and the P-VOL 202A. Since the difference extraction function unit 204 is a part of the basic function of the snapshot function, a detailed description of the difference extraction function unit 204 is omitted, and the difference extraction function unit 204 refers to the volume control table 405, compares the physical addresses 701 for the same logical address 700 among the plurality of volumes of a difference extraction target, and extracts the difference data indicating the difference between the plurality of volumes.

Next, in step S907, the snapshot migration function unit 411 uses the difference extraction function unit 204 to calculate inter-generation difference data indicating the difference between the SS-VOL 203 selected in step S905 and the SS-VOL 203 of the next generation. When the selected snapshot is the SS-VOL 203A3 shown in FIG. 2, the snapshot migration function unit 411 calculates the inter-generation difference data indicating a difference between SS-VOL 203A3 and SS-VOL 203A4. On the other hand, when the selected snapshot is the SS-VOL 203A4 shown in FIG. 2, the snapshot migration function unit 411 can omit execution of a part of the corresponding processing because there is no SS-VOL 203 of the next newer generation. In this case, the snapshot migration function unit 411 executes copy processing of the parent-child difference data in step S910.

The snapshot migration function unit 411 compares the parent-child difference data calculated in step S906 with the inter-generation difference data calculated in step S907 (step S908). When a difference amount of the parent-child difference data is equal to or smaller than a difference amount of the inter-generation difference data (step S908: Yes), the snapshot migration function unit 411 executes step S910 of transferring the parent-child difference data to the migration destination, and when the difference amount of the parent-child difference data is larger than the difference amount of the inter-generation difference data (step S908: No), the snapshot migration function unit 411 executes step S909 for transferring the inter-generation difference data to the migration destination.

When the difference amount of the parent-child difference data is larger than the difference amount of the inter-generation difference data (No in 908), that is, when the difference amount of the inter-generation difference data is smaller than the difference amount of the parent-child difference data, the snapshot migration function unit 411 transfers the inter-generation difference data to the migration destination to prevent an increase in a transfer data amount and an amount of consumption of the storage area in the migration destination. When the SS-VOL 203A3 in FIG. 2 is selected in step S905, the snapshot migration function unit 411 transfers the inter-generation difference data between the SS-VOL 203A3 and the SS-VOL 203A4 to the SS-VOL 203B3 of the migration destination storage node 101B. In order to reproduce the data of the SS-VOL 203A3 in the SS-VOL 203B3 only by transferring the inter-generation difference data indicating the difference between the SS-VOL 203A3 and the SS-VOL 203A4, it is necessary to reproduce the same data as the SS-VOL 203B4 of the migration destination storage 101B having the same data as the already migrated SS-VOL 203A4 in the SS-VOL 203B3. Therefore, in step S909, the snapshot migration function unit 411 copies the image of the next new SS-VOL 203B4 of the migration destination to the SS-VOL 203B3 of the selected generation. The copy processing in step S909 may be a copy function between volumes based on the snapshot function unit 408, or may be copied to a designated volume as a part of the snapshot function unit 408.

After executing step S909 as described above, in step S910, the snapshot migration function unit 411 differentially copies the inter-generation difference data to the migration destination SS-VOL 203. Here, the processing of calculating the logical address 700 at which the difference data exists using the difference extraction function unit 204 may be performed with the execution of step S910 as a trigger, or the difference data may be transferred using information stored in a BitMap format or the like when the difference amount is obtained in step S906. In step S905, when the SS-VOL 203A3 in FIG. 2 is selected, the snapshot migration function unit 411 transfers, to the SS-VOL 203B3 of the migration destination storage node 101B, difference data indicating a difference between the SS-VOL 203A3 and the SS-VOL 203A4.

When the difference amount of the parent-child difference data is equal to or less than the difference amount of the inter-generation difference data (step S908: Yes), the snapshot migration function unit 411 transfers the parent-child difference data to the migration destination to prevent an increase in the transfer data amount and the amount of consumption of the storage area in the migration destination. In step S911, the snapshot migration function unit 411 differentially copies the parent-child difference data to the migration destination snapshot volume 203. When the SS-VOL 203A3 in FIG. 2 is selected in step S905, the snapshot migration function unit 411 transfers difference data indicating a difference between the SS-VOL 203A3 and the P-VOL 202A to the SS-VOL 203B3 of the migration destination storage node 101B. Since the SS-VOL 203B4 is the snapshot volume created from the P-VOL 202B in step S903, the SS-VOL 203B4 originally has the same image as the P-VOL 202B. Therefore, step S909 is unnecessary, for example, when the parent-child difference data is transferred.

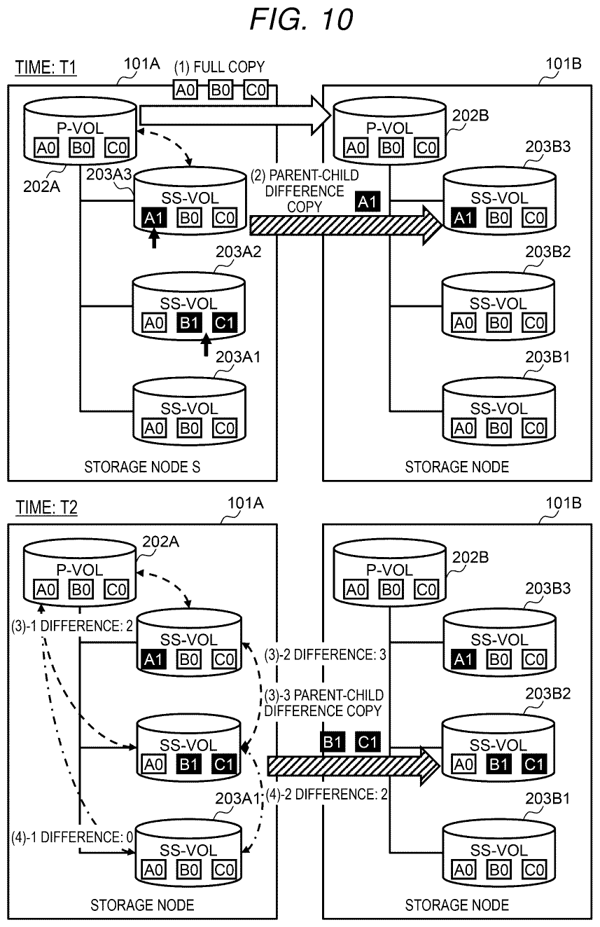

FIG. 10 is a diagram illustrating an effect produced by the storage system 100 according to the first embodiment. First, when illustrating the data control method, the data control method is a data control method of the storage system 100 having the above-described configuration, and the migration source storage node 101A transfers the parent-child difference data to the migration destination storage node 101B when the parent-child difference data indicating a difference between the migration source P-VOL 202A and the plurality of migration sources SS-VOL 203A1 to 203A4 is smaller than the inter-generation difference data indicating the difference between the plurality of migration sources SS-VOL 203A1 to 203A4, and creates the migration destination P-VOL 202B and the plurality of migration destinations SS-VOL 203B1 to 203B4 in the migration destination storage node 101B using the parent-child difference data. Hereinafter, details will be described.

The shown example shows a logical configuration when the snapshot migration function unit 411 migrates the P-VOL 202A and the SS-VOLs 203A1 to 203A3 of the migration source storage node 101A to the migration destination storage node 101B. An example of a state in which processing is executed by the snapshot migration function unit 411 from the time T1 to the time T2 is shown. Since the states of the data of the P-VOL 202 and the SS-VOLs 203A1 to 203A3 before the execution of the migration processing are substantially the same as the states shown in FIG. 3, the description thereof will be partially omitted.

At the time T1, as a procedure (1), all pieces of data of the P-VOL 202A are fully copied to the P-VOL 202B of the migration destination storage node 101B (step S902). Thereafter, the SS-VOLs 203B1 to 203B3 are created from the P-VOL 202B of the migration destination storage node (step S903). In a procedure (2), the SS-VOL 203A3 is selected as the migration target SS-VOL. The data set A1, which is difference data indicating a difference between the SS-VOL 203A3 and the P-VOL 202A, is differentially copied to the SS-VOL 203B3 (step S911).

At the time T2, as a procedure (3)-1, the SS-VOL 203A2 is selected as the migration target SS-VOL, the difference amount of the parent-child difference data indicating the difference between the SS-VOL 203A2 and the P-VOL 202A is calculated, and it is understood that the difference amount of the parent-child difference data is 2 (step S906). In a procedure (3)-2, the difference amount of the inter-generation difference data between the SS-VOL 203A2 and the SS-VOL 203A3 of a next generation is calculated, and it is understood that the difference amount of the inter-generation difference data is 3 (step S907). As a result, the difference amount of the parent-child difference data is equal to or less than the difference amount of the inter-generation difference data. Therefore, in a procedure (3)-3, the data sets B1 and C1 of the parent-child difference data are differentially copied to the SS-VOL 203B2 of the migration destination storage 101B (step S911).

In a procedure (4)-1, the SS-VOL 203A1 is selected as the migration target SS-VOL, the difference amount of the parent-child difference data indicating the difference between the SS-VOL 203A1 and the P-VOL 202A is calculated, and it is understood that the difference amount of the parent-child difference data is 0 (step S906). In a procedure (4)-2, inter-generation difference data between the SS-VOL 203A1 and the SS-VOL 203A2 of a next generation is calculated, and it is understood that the difference amount of the inter-generation difference data is 2 (step S907). As a result, since the difference amount of the parent-child difference data is equal to or less than the difference amount of the inter-generation difference data, the parent-child difference data is differentially copied to the migration destination, but since the difference amount of the parent-child difference data is 0 and no difference occurs, the copy of the difference data is unnecessary.

As a result of the migration of the P-VOL 202 and the SS-VOL 203 by the snapshot migration function unit 411, the data sets transferred to the migration destination storage node 101B are only the data sets A0, B0, and C0 transferred in the fully copy of the procedure (1) and the data sets A1, B1, and C1 6 transferred in the copy of the difference data. In the example shown in FIG. 9 as well, similarly to the example shown in FIG. 3 described above, the same data set is not transferred twice, and it is possible to prevent an increase in the amount of consumption of the storage area in the migration destination.

In FIG. 10, it is assumed that the snapshot volume is updated for the purpose of deploying the virtual machine, and the effect of the present embodiment is described, whereas even when the primary volume is updated for the purpose of backup, the present embodiment can perform migration while maintaining the same capacity consumption as the migration source even in the migration destination. That is, in the present embodiment, it is possible to prevent an increase in the amount of consumption of the storage area of the migration destination storage node 101B even when the P-VOL 202 as the primary volume is updated for the backup purpose and even when the SS-VOL 203 as the snapshot volume is updated for the purpose of deploying the virtual machine. The snapshot migration function unit 411 calculates the parent-child difference data indicating the difference between the P-VOL 202 and the SS-VOL 203 and the inter-generation difference data indicating the difference between the plurality of SS-VOLs 203, compares the difference amounts of both in step S908, and transfers the difference data having the smaller difference amount of both, so that it is possible to prevent an increase in the amount of consumption of the storage area of the migration destination storage node 101B for both purposes.

The first embodiment is described so far. In the present embodiment, the difference amount of the parent-child difference data indicating the difference between the P-VOL 202 and the SS-VOL 203 and the difference amount of the inter-generation difference data indicating the difference between the plurality of SS-VOL 203 are calculated, the difference amounts of both are compared, and the difference data having the smaller difference amount is transferred, and preferably, the difference amount of all pieces of the difference data between the P-VOL 202 and each of the SS-VOLs 203 may be calculated, and the difference data of the SS-VOL 202 may be transferred in order of the smallest difference amount.

The storage system 100 according to the embodiment is the storage system 100 including a plurality of storage nodes each having the CPU 104 as an example of a processor, and the storage node includes a volume and a plurality of snapshot volumes that are snapshots of the volume. When the volume and the plurality of snapshot volumes are migrated from the migration source storage node 101A to the migration destination storage node 101B, the migration source storage node 101A transfers data of the volume and parent-child difference data indicating a difference between the volume and the plurality of snapshot volumes to the migration destination storage node 101B, and the migration destination storage node 101B creates the volume and the plurality of snapshot volumes in the migration destination storage node 101B using the received data of the volume and the received parent-child difference data. The snapshot volume is created by duplicating a volume, and is writable into the snapshot volume after creation.

More specifically, the storage system 100 according to the present embodiment includes a plurality of storage node storage nodes 101A and 101B having the CPU 104 as an example of a processor. In the storage system 100, each of the plurality of storage node storage nodes 101A and 101B includes a volume and a plurality of snapshot volumes that are snapshots of the volume. When the volume and the plurality of snapshot volumes are migrated from the migration source storage node 101A to the migration destination storage node 101B, the migration source storage node 101A transfers the data of the volume to the migration destination storage node 101A, compares the total amount of the difference amount of the parent-child difference data indicating a difference between the migration source P-VOL 202A as a migration target and the plurality of migration sources SS-VOL 203A1 to 203A4 with the total amount of the difference amount of the inter-generation difference data indicating the inter-generation difference among the plurality of migration sources SS-VOL 203A1 to 203A4, and transfers the parent-child difference data to the migration destination storage node 101B when the difference amount of the parent-child difference data is smaller than the difference amount of the inter-generation difference data. Further, when the difference amount of the inter-generation difference data is smaller than the difference amount of the parent-child difference data, the migration source storage node 101A transfers the inter-generation difference data to the migration destination storage node 101B. The migration destination storage node 101B associates the migration destination P-VOL 202B and the plurality of migration destinations SS-VOL 203B1 to 203B4 with the migration destination storage node 101B using the received volume data and the received parent-child difference data.

With such a configuration, it is possible to prevent an increase in the amount of consumption of the storage area in the migration destination regardless of whether the primary volume is updated for backup or the snapshot volume is updated for deployment of the virtual machine.

In the present embodiment, the snapshot volume is created by duplicating a volume, and is writable into the snapshot volume after creation.

In the present embodiment, the migration source storage node 101A compares the migration source P-VOL 202A with the plurality of migration sources SS-VOL 203A1 to 203A4, and extracts the parent-child difference data and the inter-generation difference data. The migration source storage node 101A determines the parent-child difference data or the inter-generation difference data to be transferred to the migration destination storage node 101B. In this way, since the difference data having the smaller difference amount among the parent-child difference data and the inter-generation difference data is transferred to the migration destination storage node 101B, it is possible to further prevent an increase in the amount of consumption of the storage area in the migration destination even when the primary volume is updated for the backup purpose and even when the snapshot volume is updated for the purpose of deploying the virtual machine.

In the present embodiment, the migration source storage node 101A transfers the inter-generation difference data, and the migration destination storage node 101B copies the snapshot image between the generations of the snapshot volume of the migration destination storage node 101B. Specifically, when the inter-generation difference data between the plurality of migration sources SS-VOL 203A1 to 203A4 of the migration source storage node 101A is transferred to the migration destination storage node 101B, the snapshot image is copied between target generations of the migration destinations SS-VOL 203B1 to 203B4 in order to reproduce the migration sources SS-VOL 203A1 to 203A4 in the migration destinations SS-VOL 203B1 to 203B4 with only the inter-generation difference data. In this way, it is possible to further prevent an increase in the amount of consumption of the storage area in the migration destination, even when the primary volume is updated for the backup purpose, or even when the snapshot volume is updated for the purpose of deploying the virtual machine, using the snapshot images copied between the same generations of the plurality of migration sources SS-VOL 203A1 to 203A4.

### (2) Second Embodiment

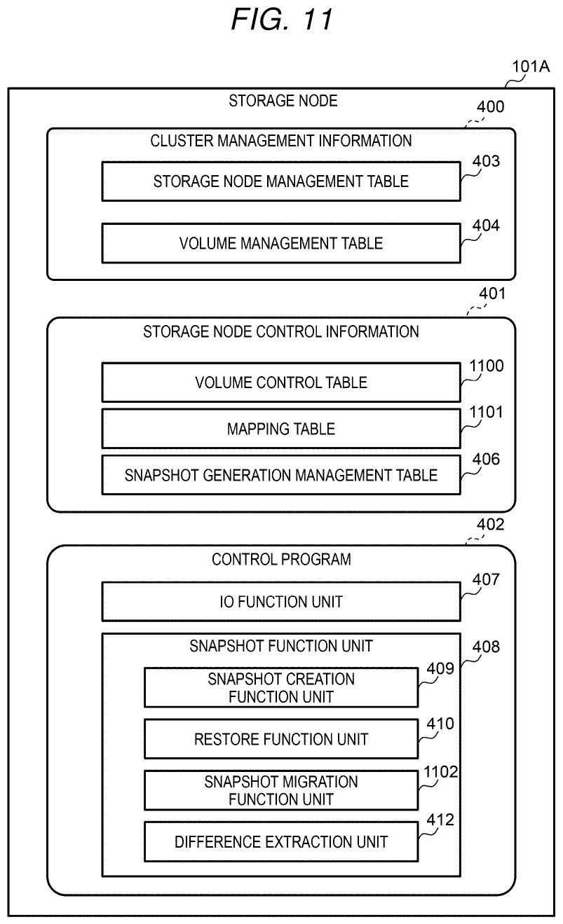

Since a storage system according to a second embodiment has an almost similar configuration and operation as the storage system 100 according to the first embodiment, description of the similar configuration and operation will be omitted, and different points will be mainly described below. The second embodiment will be described with reference to FIGS. 11 to 15.

In the first embodiment, the parent-child difference data indicating the difference between the P-VOL 202 and the SS-VOL 203 and the inter-generation difference data indicating a difference between the plurality of SS-VOL 203 are extracted, and the difference data is transferred to the migration destination according to the difference amount between the two pieces of difference data. In contrast, the second embodiment is different from the first embodiment in that the data image of the P-VOL 202 is not only a latest data image, but also has the data image for each time when each of the SS-VOLs 203 is created. In the second embodiment, a storage system having a function of managing a data image of the P-VOL 202 for each time when each SS-VOL 203 is created as information of the generation of the SS-VOL 203 will be described.

FIG. 11 is a functional block diagram showing a logical configuration example of the storage node 101A according to the second embodiment. As compared with the storage node 101 according to the first embodiment shown in FIG. 4, in the second embodiment, a mapping table 1101 is added as the storage node control information 401, and the volume control table 1100 is partially updated. As the control program 402, the snapshot migration function unit 1102 is partially updated.

The mapping table 1101 is a table for converting a logical address designating a data position to be read and written by the host 102 and a physical address indicating a position in the storage device 106 where a data block of the logical address is stored. That is, the data images of the P-VOL 202 and the SS-VOL 203 are determined by the table. In the second embodiment, since each SS-VOL 203 has two images, a P-VOL data image at the time of creating the SS-VOL 203 and a latest image of the SS-VOL itself, a table number of a mapping table 1101 can be managed from a volume control table 1100.

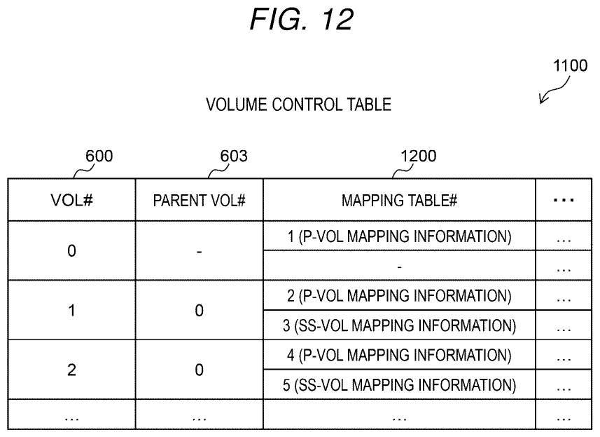

FIG. 12 is a diagram showing a configuration example of the volume control table 1100A according to the second embodiment. As compared with the corresponding volume control table 1100 shown in FIG. 7 in the first embodiment, a logical address 700 and a physical address 701 are omitted from the volume control table 1100A, and a mapping table #1200 is added.

The mapping table #1200 is information for uniquely identifying a table number of the mapping table 1101. The mapping table #1200 manages two mapping tables #for each volume #600. The P-VOL 202 manages one P-VOL mapping information, and the SS-VOL 203 manages two mapping information of the P-VOL and the SS-VOL itself. The P-VOL 202 whose parent volume #603 is “−” has only the P-VOL mapping information, which is the latest image of the P-VOL 202, as the mapping table #1100. On the other hand, the SS-VOL 203 whose parent volume #603 is a valid value has two pieces of information: SS-VOL mapping information which is the latest image of the SS-VOL 203 and P-VOL mapping information which is a P-VOL data image at the time of creating the SS-VOL 203.

In the shown example, a volume in which the volume #600 is “1” is a volume created as a snapshot of a primary volume in which the volume #600 is “0”. The mapping table #1200 includes “2” and “3”. “2” is P-VOL mapping information that is a P-VOL data image at the time when the SS-VOL 203 in which the volume #600 is “1” is created. “3” is SS-VOL mapping information which is the latest image of the SS-VOL 203 whose volume #600 is “1”.

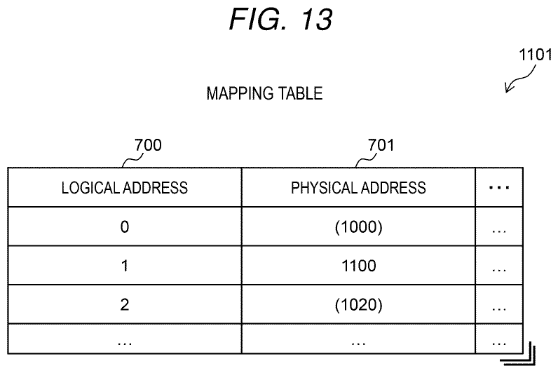

FIG. 13 is a diagram showing a configuration example of the mapping table 1101 according to the second embodiment. The mapping table 1101 is a table to be used to convert a logical address designating a data position to be read and written by the host 102 and a physical address indicating a position in the storage device 106 where a data block of the logical address is stored. The mapping table 1101 includes the logical address 700 and the physical address 701 as components of the mapping table 1101. The logical address 700 and the physical address 701 are the same as the logical address 700 and the physical address 701 shown in FIG. 7 in the first embodiment, respectively.

In the shown example, a data block whose logical address 700 is “0” shares data with the primary volume, and is stored in an area whose physical address 702 is “1000”. A data block whose logical address 700 is “1” is stored in an area whose physical address 701 is “1100”. A data block whose logical address 700 is “2” shares data with the primary volume, and is stored in an area whose physical address 701 is “1020”.

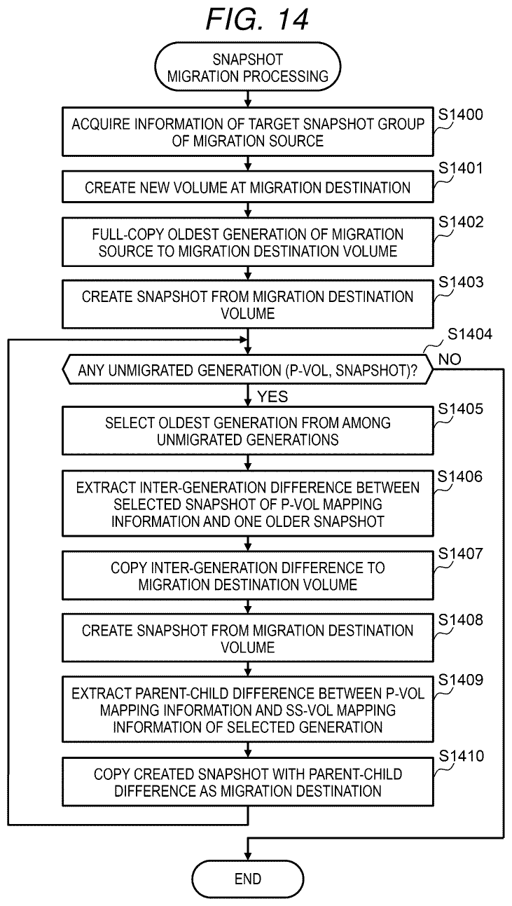

FIG. 14 is a flowchart showing an example of a procedure of a snapshot migration processing according to the second embodiment. The snapshot migration processing is mainly executed by the snapshot migration function unit 1102. The snapshot migration function unit 1102 corresponds to the snapshot migration function unit 411 in the first embodiment. Similarly to the flowchart shown in FIG. 9 in the first embodiment, the snapshot migration function unit 1102 may be activated by instructing the execution of the migration processing, or may be implemented such that, when the control program 402 in the storage system 100 detects the deviation of the storage capacity or the calculation load, the migration for eliminating the deviation is autonomously activated.

In the present snapshot migration processing, first, the snapshot migration function unit 1102 acquires information related to the target snapshot group 201 serving as a migration source (step S1400). The snapshot migration function unit 1102 refers to the volume management table 404 and acquires volume information necessary for migration such as the volume #600, the node ID 500, the volume capacity 601, the volume attribute 602, and the parent volume #603 of the migration target snapshot group #604. The step S1400 is the same as step S900 in FIG. 9.

Next, in step S1401, the snapshot migration function unit 1102 creates a new volume having the same capacity as the migration source P-VOL 202 or SS-VOL 203 in the migration destination storage node 101 based on the information of the volume capacity 601 acquired in step S1400. The processing is the same as step S901 in FIG. 9.

Next, in step S1402, the snapshot migration function unit 1102 copies all pieces of data of the oldest generation SS-VOL 203 of the migration source storage node 101A to the migration destination volume created in step S1401. In the present embodiment, the snapshot migration function unit 1102 migrates the difference data in order from the oldest generation SS-VOL 203, but the migration may be performed from the latest generation P-VOL 202 as in the first embodiment. However, as described in step S909 of FIG. 9, when the inter-generation difference data is transferred, processing of giving the same data image between generations is additionally required even in the migration destination storage node 101B, and therefore, in the present embodiment, as an example, a method for sequentially migrating from the oldest generation SS-VOL 203 will be described.

Next, in step S1403, the snapshot migration function unit 1102 creates the SS-VOL 203B1 from the P-VOL 202B of the migration destination storage node 101B. Accordingly, the migration processing of a last-generation snapshot volume (for example, migration from the SS-VOL 203A1 to the SS-VOL 203B1 in FIG. 2) is completed.

In step S1404, the snapshot migration function unit 1102 checks whether unmigrated SS-VOL 203 and P-VOL 202 still exist in the migration source storage node 101A. Information related to whether the migration processing is completed may be held in the volume management table 404 or in the state 804 of the snapshot generation management table 406. When the snapshot migration function unit 1102 determines that there is an unmigrated snapshot (step S1403: Yes), the snapshot migration function unit 1102 proceeds to step S1404, and when there is no unmigrated snapshot (step S1403: No), that is, when all the migration processing is completed, the snapshot migration function unit 1102 ends the processing.

In step S1405, the snapshot migration function unit 1102 selects the oldest generation of the unmigrated SS-VOL 203 and P-VOL 202. In a state after copy of all pieces of data of the oldest generation SS-VOL 203A1 are completed, the snapshot migration function unit 1102 selects, for example, the SS-VOL 203A2 in FIG. 2.

Next, in step S1406, the snapshot migration function unit 1102 extracts inter-generation difference data between the selected generation (the SS-VOL 203 or the P-VOL 202) of the P-VOL mapping information and the SS-VOL 203 of one older generation. Specifically, in the volume control table 1100 shown in FIG. 12, when the snapshot volume #600 of the selected generation is “2” and the snapshot volume #600 of the next older generation is “1”, the snapshot migration function unit 1102 extracts difference data indicating a difference between the P-VOL mapping information of “4” and the P-VOL mapping information of “2” in the mapping table #1200.

As described with reference to FIG. 12, the P-VOL mapping information managed by the SS-VOL 203 is a data image of the P-VOL 202 at the time of creating the SS-VOL 203. That is, by extracting the difference data indicating the difference between the P-VOL data image at the time of creating the SS-VOL 203 of the selected generation and the P-VOL data image at the time of creating the SS-VOL 203 of one older generation, update data for the P-VOL 202 from the time of creating the SS-VOL 203 of the one older generation to the time of creating the SS-VOL 203 of the selected generation can be grasped.

In step S1407, the snapshot migration function unit 1102 copies the difference data due to the update of the P-VOL 202 extracted in step S1406 to the P-VOL 202B of the migration destination storage node 101B. Accordingly, the P-VOL data image at the time of creating SS-VOL 203, which is the selected generation of the migration source storage node 101A, can be reproduced in P-VOL 202B of the migration destination storage node 101B.

Next, in step S1408, the snapshot migration function unit 1102 creates the SS-VOL 203B from the P-VOL 202B of the migration destination storage node 101B. Accordingly, the P-VOL data image at the time of creating the SS-VOL 203A which is the selected generation of the migration source storage node 101A, that is, the data state at the time of creating the SS-VOL 203A which is the selected generation can be reproduced in the SS-VOL 203B of the migration destination storage node 101B.

Next, in step S1409, the snapshot migration function unit 1102 extracts the P-VOL mapping information of the selected generation SS-VOL 203 and the parent-child difference data of the SS-VOL mapping information. Specifically, when the snapshot volume #600 of the selected generation is “2” in the volume control table 1100 of FIG. 12, the snapshot migration function unit 1102 extracts difference data indicating a difference between the P-VOL mapping information of “4” and the SS-VOL mapping information of “5” in the mapping table #1200.

The P-VOL mapping information managed by the SS-VOL 203 is a data image of the P-VOL 202 at the time of creating SS-VOL 203, that is, a data image of the SS-VOL 203 immediately after the SS-VOL 203 is created. On the other hand, since the SS-VOL mapping information is the latest image of the SS-VOL itself, in the processing, data updated for the SS-VOL after creation of the SS-VOL 203 is extracted. When the generation as the migration target is P-VOL 202, the SS-VOL mapping information is not included, and thus step S1409 and step S1410 are unnecessary.

Finally, in step S1410, the snapshot migration function unit 1102 copies the parent-child difference data extracted in the processing 1409 to the SS-VOL 203B of the migration destination storage node 101B created in step S1408. The state of the SS-VOL 203B before copying the parent-child difference data is the data state at the time of creating the SS-VOL 203A which is the selected generation. Therefore, the snapshot migration function unit 1102 can migrate the data of the migration source SS-VOL 203A to the migration destination SS-VOL 203B by copying the updated parent-child difference data to the SS-VOL after creating the SS-VOL 203A.

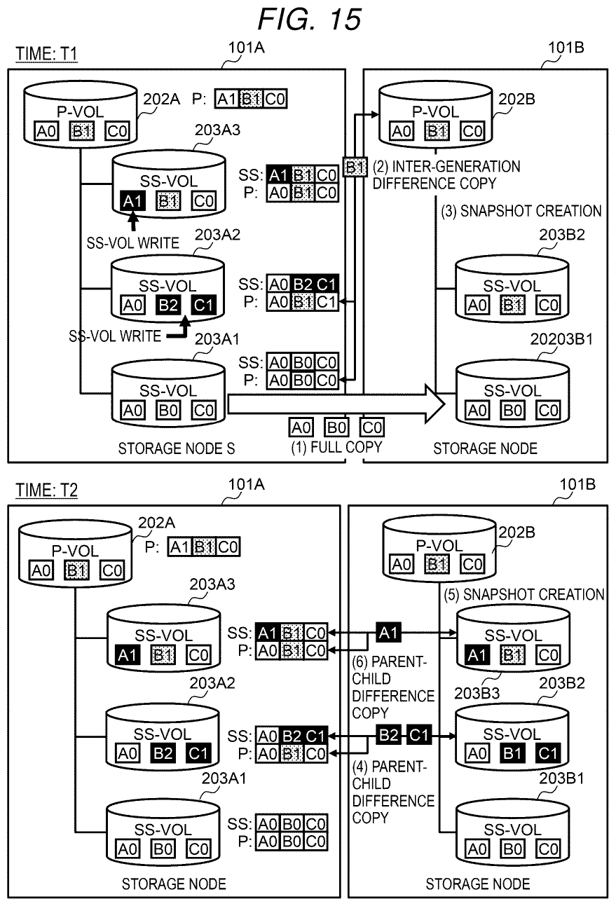

FIG. 15 is a diagram illustrating effects of the second embodiment. FIG. 15 shows a logical configuration when the P-VOL 202A and the SS-VOLs 203A1 to 203A3 of the migration source storage node 101A are migrated to the migration destination storage node 101B using the snapshot migration function unit 1102. As the processing proceeds from the time T1 to the time T2, the processing performed by the snapshot migration function unit 1102 proceeds. The states of the data of the P-VOL 202 and the SS-VOLs 203A1 to 203A3 before the migration are slightly different from the states shown in FIG. 3 in order to facilitate the description of the effects of the present embodiment. Specifically, although the update to the SS-VOL 203 is the same as in FIGS. 3 and 10, an example in which a part of the P-VOL 202 is also updated is shown.

First, the state of the migration source storage node 101A before the snapshot migration will be described. First, the data sets A0, B0, and C0 are written to the P-VOL 202A from the host 102, and the SS-VOL 203A1 is created from the P-VOL 202. Thereafter, the data set B1 is written to the P-VOL 202A, and B0 is updated to B1. Thereafter, the SS-VOL 203A2 is created from the P-VOL 202, and the SS-VOL of the data sets A0, B1, and C0 is created. However, similarly to the first embodiment and the like, the SS-VOL 203A2 is in a state in which the data sets B2 and C1 are written from the host 102 and B1 and C0 are updated to B2 and C1. The SS-VOL 203A3 is also created from the P-VOL 202A, and the SS-VOL 203A3 of the data sets A0, B1, and C0 is created. As in the first embodiment and the like, there is a state in which the data set A1 is written from the host 102, and the data set A0 is updated to the data set A1. Further, six or three squares shown on the right side of each of the SS-VOL 203 and the P-VOL 202 of the migration source storage node 101A correspond to the P-VOL mapping information (“P” in FIG. 15) and the SS-VOL mapping information (“SS” in FIG. 15) described in FIG. 12. That is, the P-VOL mapping information is the data image of the P-VOL 202 at the time of creating the SS-VOL 203, and the SS-VOL mapping information is the latest data image of the SS-VOL 203 itself.

At the time T1, as a procedure (1), all pieces of data of the oldest generation SS-VOL 203A1 are fully copied to the P-VOL 202B of the migration destination storage node 101B (step S1402). Thereafter, the SS-VOL 203B1 is created from the P-VOL 202B of the migration destination storage node (step S1403).

In a procedure (2), the SS-VOL 203A2 is selected as the migration target SS-VOL, and the data set B1, which is inter-generation difference data of the P-VOL mapping information between the SS-VOL 203A2 and the SS-VOL 203A3 of one older generation, is differentially copied to the P-VOL 202B (step S1407). The data set B1 is data updated to the P-VOL 202 between the creation of the SS-VOL 203A1 and the creation of the SS-VOL 203A2.

Thereafter, in a procedure (3), the SS-VOL 203B2 is created from the P-VOL 202B (processing 1408) of the snapshot migration function unit 1102). By the processing, the data sets A0, B1, and C0 immediately after creation of the SS-VOL 203A2 can be reproduced in the SS-VOL 203B2.

At the time T2, as a procedure (4), the data sets B2 and C1, which are parent-child difference data indicating a difference between the P-VOL mapping information and the SS-VOL mapping information of the SS-VOL 203A2, are extracted and copied to the SS-VOL 203B2 of the migration destination storage node 101B (step S1410 executed by the snapshot migration function unit 1102). By the processing, the data sets B2 and C1 updated to the SS-VOL after the SS-VOL 203A2 is created are copied to the SS-VOL 203B2, and the migration source SS-VOL 203A2 is migrated to the migration destination SS-VOL 203B2.

Next, in a procedure (5), the SS-VOL 203A3 is selected as the migration target SS-VOL, and the SS-VOL 203B3 is created from the migration destination P-VOL 202B. Since an inter-generation difference of the P-VOL mapping information between the SS-VOL 203A3 and the SS-VOL 203A2 of one older generation as in the procedure (2) is the same image (data sets A0, B1, and C0), the difference data does not exist, and the copy processing of the inter-generation difference data is unnecessary. That is, it is indicated that the P-VOL 202 is not updated between the time of creating the SS-VOL 203A2 and the time of creating the SS-VOL 203A3.

Finally, in a procedure (6), the snapshot migration function unit 1102 extracts the data set A1 that is parent-child difference data indicating a difference between the P-VOL mapping information and the SS-VOL mapping information of the SS-VOL 203A3, and copies the data set A1 to the SS-VOL 203B3 of the migration destination storage node 101B. Accordingly, the data set A1 updated to the SS-VOL after creation of the SS-VOL 203A3 is copied to the SS-VOL 203B3, and the migration source SS-VOL 203A3 is migrated to the migration destination SS-VOL 203B3. The snapshot migration function unit 1102 extracts the inter-generation difference data indicating the difference between the P-VOL 202 and the SS-VOL 203A3 of the P-VOL mapping information in the next processing (step S1406), but since all the data sets A0, B1, and C0 are the same, the differentially copy is unnecessary, and the snapshot migration function unit 1102 ends the processing.

As a result of migrating the P-VOL 202 and the SS-VOL 203, the data sets transferred to the migration destination storage node 101B are only seven data sets of the data sets A0, B0, and C0 transferred in the fully copy of the procedure (1) and the data set B1 which is the inter-generation difference data generated in the P-VOL update (the procedure (2)) and the data sets B2, C1, and A1 which are the parent-child difference data generated in the SS-VOL update (the procedure (4) and the procedure (6)). The reason why the transfer of the data set B1 increases as compared with FIG. 10 in the first embodiment is that the update of the data set B1 also occurs in the P-VOL 202 as a state before the migration, and an amount of difference data of the migration source increases.

According to the present embodiment, the same data set is not transferred twice as in FIG. 3 described above, and it is possible to prevent an increase in the amount of consumption of the storage area in the migration destination. According to the present embodiment, it is possible to prevent an increase in the amount of consumption of the storage area at the migration destination both when the primary volume is updated and when the snapshot volume is updated.

The storage system 100 according to the present embodiment is a storage system including a plurality of storage nodes each including a processor, and each storage node includes a volume and a plurality of snapshot volumes that are snapshots of the volume. The snapshot volume is created by duplicating a volume, can be written to the created snapshot volume, is a snapshot image at the time of creating the snapshot volume, and has a snapshot image before being written to the snapshot volume. When a volume and a plurality of snapshot volumes are migrated from the migration source storage node 101A to the migration destination storage node 101B, the migration source storage node 101A transfers, to the migration destination storage node 101B, volume data, inter-generation difference data indicating a difference between the snapshot volumes when the plurality of snapshots are created, and parent-child difference data which is write data to the snapshot volume after creation, and the migration destination storage node 101A uses the received volume data, the received inter-generation difference data, and the received parent-child difference data to associate the volume with the plurality of snapshot volumes at the migration destination storage node 101A.

### (3) Third Embodiment

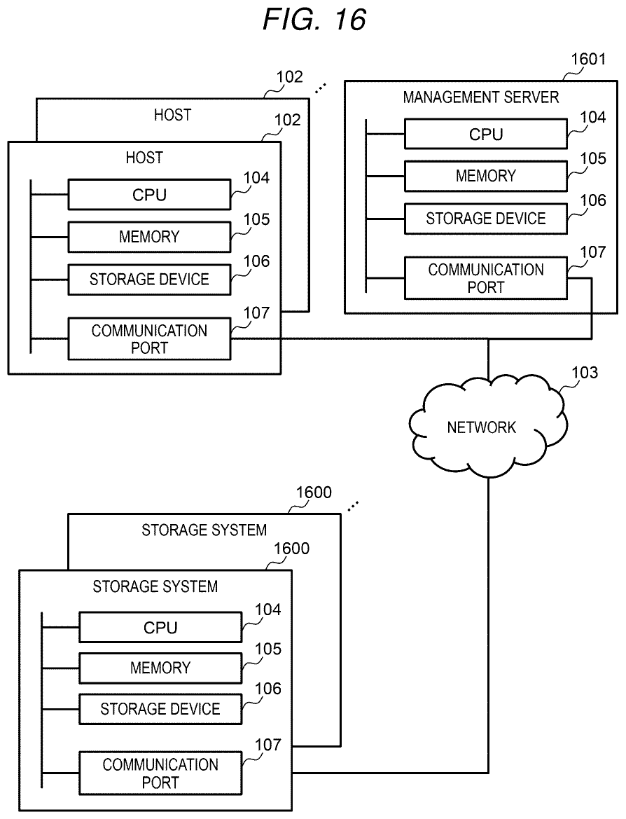

Since a storage system according to a third embodiment has an almost similar configuration and operation as the storage system 100 according to the first embodiment and the storage system according to the second embodiment, description of the similar configuration and operation will be omitted, and different points will be mainly described below. The third embodiment will be described with reference to FIGS. 16 to 20.

In the first embodiment and the second embodiment, the storage system 100 has a cluster configuration including two or more storage nodes 101. On the other hand, in the third embodiment, as will be described later, a configuration using a virtual storage scale out (VSSO) that is a scale-out function enabling a plurality of storage systems to be handled as a single mass storage system by arranging two or more storage systems and defining the same virtual storage machine (VSM) for the plurality of storage systems 100 will be described.

FIG. 16 is a block diagram showing a configuration example of an entire system including a storage system according to the third embodiment. As compared with the configuration of the storage system 100 according to the first embodiment shown in FIG. 1 in the first embodiment, two or more storage systems 1600 according to the third embodiment are arranged. Similarly to the storage system 100 according to the first embodiment, the storage system 1600 may include a plurality of storage nodes 101. A management server 1601 for managing the two or more storage systems 1600 is added.

In the storage system according to the third embodiment, the management server 1601 defines the same virtual storage machine (VSM) for the plurality of storage systems, so that the plurality of storage systems can be treated as a single mass storage system. The storage system 1600, the host 102, and the management server 1601 do not need to be installed at the same location, and for example, the storage system 1600 and the host 102 may be installed in different data centers. Similarly, the storage system 1600 and the host 102 may be physically implemented by one device. For example, like a Hyper Converged Infrastructure (HCI), a configuration may be adopted in which the function as the storage system 1600 and the function as the host 102 are shared by one physical server.

The storage systems 1600, the hosts 102, and the management server 1601 are connected to a network 103 and can communicate with each other. The network 103 is implemented by any communication line such as Ethernet, InfiniBand, or an optical fiber and a combination thereof. In addition, the network 103 may include not only a local area network (LAN) closed in a data center but also a wide area network (WAN) such as the Internet and a virtual network inside a computer.

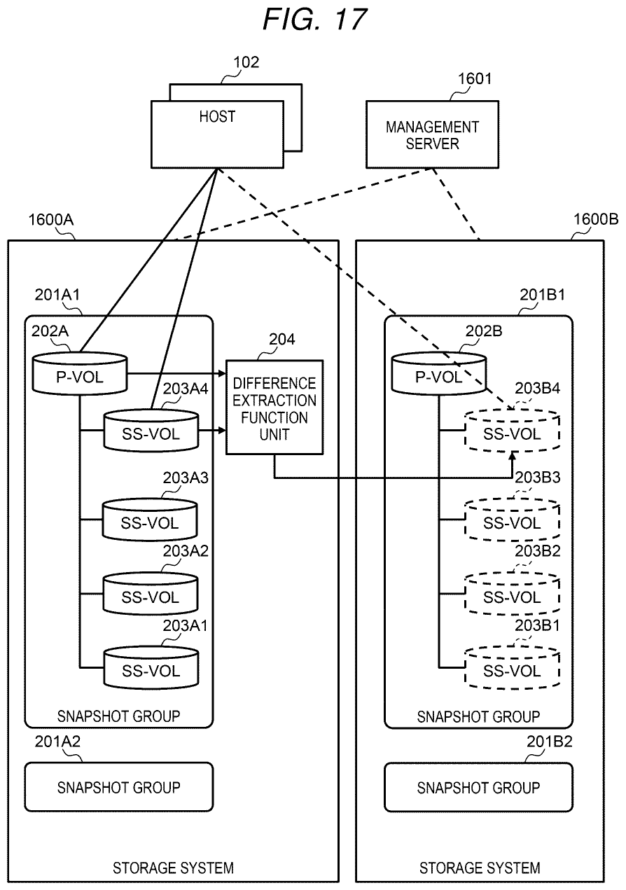

FIG. 17 is a block diagram showing an example of a logical configuration of the storage system according to the third embodiment. As compared with FIG. 2 in the first embodiment, in the third embodiment, storage systems 1600A, 1600B (hereinafter, also collectively referred to as the “storage system 1600”) are arranged, and the plurality of storage systems 1600 are managed by the management server 1601. Since the configurations of the snapshot group 201, the primary volume 202, the snapshot volume 203, and the like in the storage system 1600 are the same as those of the first embodiment and the second embodiment, the description thereof will be omitted.

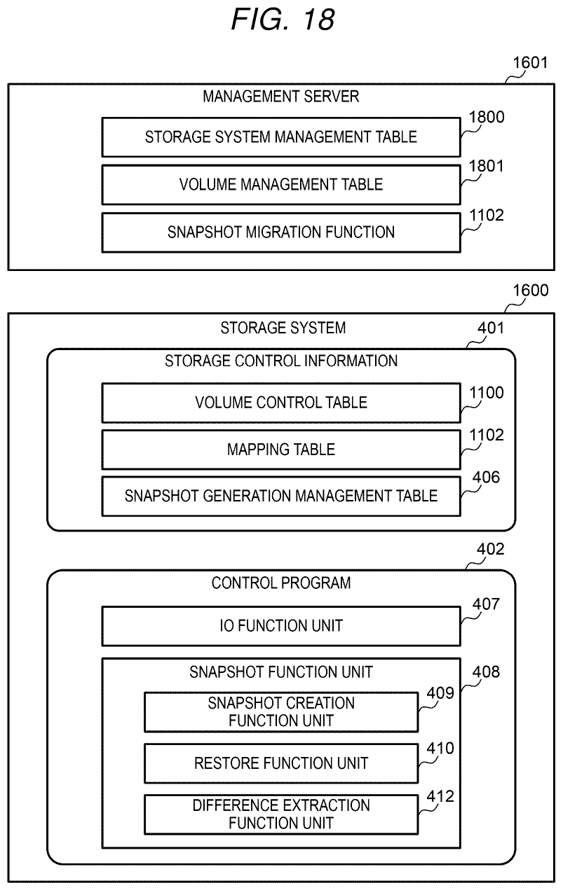

FIG. 18 is a block diagram showing a logical configuration example of the storage system 1600 and the management server 1601 according to the third embodiment. As compared with FIG. 11 in the second embodiment, in the third embodiment, a storage system management table 1800 and a volume management table 1801 are added to the management server 1601, and the snapshot migration function unit 1102 in the control program 402 of the storage node 101 is migrated to the management server 1601. The storage node management table 403 and the volume management table 404 of the cluster management information 400 in FIG. 11 correspond to the storage system management table 1800 and the volume management table 1801 in FIG. 18, respectively.

The storage system management table 1800 is a management table for operating a plurality of storage systems as a single mass storage system. The volume management table 1801 is a table for managing the configuration of volumes and snapshots of the plurality of storage systems 1600 managed by the management server 1601. The snapshot migration function unit 1102 is the same program as the snapshot migration function of the second embodiment, but is executed as a program of the management server 1601 in the present embodiment. However, the difference extraction function unit 204 still remains in the control program 402 of the storage system 1600.

The snapshot migration function unit 1102 of the management server 1601 grasps the migration target P-VOL 202 and SS-VOL 203, manages a migration procedure, progress, and the like, and determines a difference extraction target volume and the like, and the difference extraction function unit 204 of the storage system 1600 extracts difference data indicating a difference between a plurality of target volumes instructed from the snapshot migration function unit 1102 of the management server 1601, and exchanges the difference data with the management server 1601 using information such as BitMap. Transfer processing of the difference data itself may be performed by the management server 1601 or the storage system 1600.

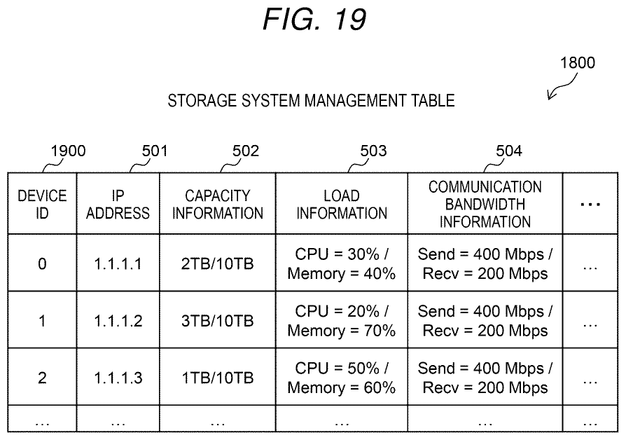

FIG. 19 is a block diagram showing a configuration example of the storage system management table 1800 according to the third embodiment. As compared with the configuration example shown in FIG. 5 in the first embodiment and the second embodiment, an entry serving as the node ID 500 is replaced with a device ID 1900 for each storage system 1600. The storage system management table 1800 is a table for managing the storage system 1600 constituting a single mass storage system in the VSSO described above. Entries of the storage system management table 1800 include the device ID 1900, the IP address 501, the capacity information 502, the load information 503, and the communication bandwidth information 504. The device ID 1900 is information for uniquely identifying the storage system 1600 managed as the VSSO. In the shown example, the ID is a serial number, and may not be a serial number and may be an ID using characters other than numbers.

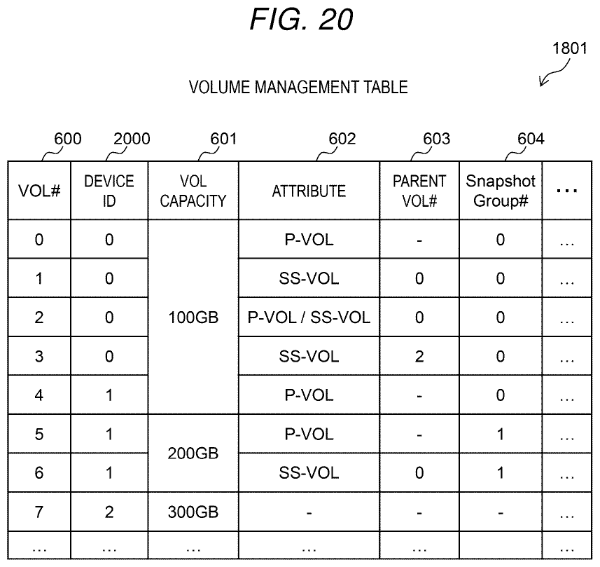

FIG. 20 is a diagram showing a configuration example of the volume management table 1801 according to the third embodiment. As compared with the configuration example shown in FIG. 6 in the first embodiment and the second embodiment, the entry serving as the node ID 500 is replaced with a device ID 2000 for each storage system. The volume management table 1801 is a table for managing the configuration of volumes and snapshots of the storage system 1600 managed by the management server 1601. Entries of the volume management table 1801 include the volume number (VOL #) 600, the device ID 2000, the volume capacity 601, the volume attribute 602, the parent volume number (parent VOL #) 603, and the snapshot group #604.

The invention is not limited to the embodiments described above, and includes various modifications and equivalent configurations within the scope of the appended claims. For example, the embodiments described above have been described in detail to facilitate understanding of the invention, and the invention is not limited to those including all the configurations described above. At least one element of the elements described as being connected in parallel in the present embodiment may be connected in series to another element.

### INDUSTRIAL APPLICABILITY

The present invention can be applied to, for example, a storage system related to a technique using a snapshot function.

What is claimed is:

1. A storage system comprising:
a plurality of storage nodes each having a processor, wherein
each of the storage nodes includes a volume and a plurality of snapshot volumes that are snapshots of the volume,
when migrating the volume and the plurality of snapshot volumes from a migration source storage node to a migration destination storage node,
the migration source storage node
transfers data of the volume to the migration destination storage node,
compares a sum of difference amounts of parent-child difference data indicating differences between the volume as a migration target and the plurality of snapshot volumes with a sum of difference amounts of inter-generation difference data indicating inter-generation differences between the plurality of snapshot volumes, and
transfers the parent-child difference data to the migration destination storage node when the difference amount of the parent-child difference data is smaller than the difference amount of the inter-generation difference data, and transfers the inter-generation difference data to the migration destination storage node when the difference amount of the inter-generation difference data is smaller than the difference amount of the parent-child difference data, and
the migration destination storage node uses the received data of the volume and the received inter-generation difference data or the received parent-child difference data to associate the volume and the plurality of snapshot volumes with the migration destination storage node.

2. The storage system according to claim 1, wherein
each of the snapshot volumes is created by duplicating the volume, and
data is writable into the snapshot volume after creation.

3. The storage system according to claim 2, wherein
the migration source storage node compares the volume with the plurality of snapshot volumes, extracts the parent-child difference data and the inter-generation difference data, and determines the parent-child difference data or the inter-generation difference data to be transferred to the migration destination storage node.

4. The storage system according to claim 1, wherein
the migration source storage node transfers the inter-generation difference data, and
the migration destination storage node copies a snapshot image between generations of the snapshot volume of the migration destination storage node.

5. A storage system comprising:
a plurality of storage nodes each having a processor, wherein each of the storage nodes includes a volume and a plurality of snapshot volumes that are snapshots of the volume, and
each of the snapshot volumes is created by duplicating the volume,
data is writable into the snapshot volume after creation, and
the snapshot volume has a snapshot image before being written into the snapshot volume, which is a snapshot image during creation of the snapshot volume,
when the volume and the plurality of snapshot volumes are migrated from a migration source storage node to a migration destination storage node,
the migration source storage node transfers, to the migration destination storage node, data of the volume, inter-generation difference data indicating differences between snapshot volumes during creation of the plurality of snapshots, and parent-child difference data that is data written into the snapshot volume after creation, and
the migration destination storage node uses the received data of the volume, the received inter-generation difference data, and the received parent-child difference data to associate the volume with the plurality of snapshot volumes in the migration destination storage node.

6. A storage system comprising:
a plurality of storage nodes each having a processor, wherein
each of the storage nodes includes a volume and a plurality of snapshot volumes that are snapshots of the volume, and
when the volume and the plurality of snapshot volumes are migrated from a migration source storage node to a migration destination storage node,
the migration source storage node transfers, to the migration destination storage node, data of the volume and parent-child difference data indicating differences between the volume and the plurality of snapshot volumes, and
the migration destination storage node uses the received data of the volume and the received parent-child difference data to create the volume and the plurality of snapshot volumes in the migration destination storage node.

7. The storage system according to claim 6, wherein
each of the snapshot volumes is created by duplicating the volume, and
data is writable into the snapshot volume after creation.
